(19) United States
(12) Patent Application Publication
(10) Pub. No.: US 2026/0252371 A1
(43) Pub. Date: Aug. 27, 2026

(54) DATA INTEGRATION IN A DATA VIRTUALIZATION PLATFORM

(71) Applicant: The PNC Financial Services Group, Inc., Pittsburgh, PA (US)

(72) Inventor: Thomas A. Savarese, Saint Charles, IL (US)

(21) Appl. No.: 19/064,133

(22) Filed: Feb. 26, 2025

(51) Int. Cl. G06F 9/455; G06F 21/62; H04L 9/32

(52) U.S. Cl. CPC G06F 9/455; G06F 21/6254; H04L 9/3213

(57) ABSTRACT

A method and system for on-demand data integration of a plurality of data sources in a data virtualization platform. The data virtualization platform comprises a plurality of semantic layers including a base layer, integration layer, and a consumption layer. The system configures the data sources to comply with data quality rules and establishes a connection between the data sources and the base layer. Once the data sources are connected to the base layer, the integration layer maps the data objects to the consumption layer for client consumption.

### BACKGROUND

Currently, data management platforms like data lake query engines may be used to aggregate data from a plurality of data sources for consumption by data consumers. The data lake query engines are built on top of the data lake environments and require data extraction from the plurality of data sources into a centralized data lake. Each data lake has its own instance of a data capability to assist the data consumers (e.g., clients) in finding data in an organized way. However, data lakes are typically built for data organization and are not built for speed of data integration and retrieval. Additionally, the data within a data lake may need to be augmented to be consistent with other data that resides in databases, that are external to the data lake itself. To accomplish this task, data lake query engines provide the capability to create a point-to-point integration with that a specific remote database. However, unlike data mesh, the data lake query engines need to pull external data into the data lake, or the query engine will have slower performance when compared to executed queries on local data.

### SUMMARY

In one general aspect, embodiments of the present invention are directed to a method for on-demand data integration. The method can comprise the step of identifying, by a server, a plurality of data objects to be integrated on-demand into a data virtualization platform, where the plurality of data objects is stored at a plurality of data sources. The method can also comprise the step of determining, by the server, a data conformity status of a first data object of the plurality of data objects, where: the data conformity status is based on a data consistency rule applied by a data catalog stored electronically by the server; and the data catalog comprises an enterprise data dictionary (EDD) and an enterprise business glossary (EBG), and a plurality of classification tags for data elements within the plurality of data objects. Then the server can obfuscate, with a tokenization algorithm, a subset of the data elements of the first data object based on a data security rule, in response to determining by the server that the data conformity status of the first data object is a conforming data object, and where the subset of the data elements of the first data object are tokenized data elements to comply with the data security rule. The method can further comprise the step of connecting, by the server, the first data object to a base layer of the data virtualization platform, in response to determining that the first data object complies with the data security rule, where the base layer comprises a mapping to a plurality of conforming data objects. The method can also comprise the steps of tagging, by the server, the data elements of the first data object based on the plurality of classification tags; and mapping, by an integration layer of the data virtualization platform, the first data object in the base layer to a consumption layer of the data virtualization platform, and where the consumption layer is the only layer of the data virtualization platform accessible to a client device.

In another general aspect, embodiments of the present invention are directed to a data virtualization system, which can comprise a global load balancer configured to: receive a plurality of query requests from a plurality of client devices; and direct a query request of the plurality of query requests to a first load balancer in a first production environment or a second load balancer in a second production environment. The system may also comprise a first deployment server and a second deployment server. The first deployment server is communicably coupled to the first load balancer in the first production environment, where the first load balancer is positioned between the first deployment server and the global load balancer. The second deployment server is communicably coupled to the second load balancer in the second production environment, where the second load balancer is positioned between the first deployment server and the global load balancer. The system may also comprise third and fourth load balancers. The third load balancer communicably coupled to the first deployment server, where the third load balancer is positioned between the first deployment server and a plurality of data sources; and the fourth load balancer communicably coupled to the first deployment server, where the third load balancer is positioned between the second deployment server and the plurality of data sources. The third load balancer is configured to: receive a first query request of the plurality of query requests; determine a first latency response time between the third load balancer and the plurality of data sources in the first production environment; determine a second latency response time between the fourth load balancer and the plurality of data sources in the second production environment, and route the first query request through the second production environment when the second latency response time is less than the first latency response time; and route the first query request through the first production environment when the first latency response time is less than the second latency response time.

Embodiments of the present invention can reduce the lead time for data availability, reduce data transfer bottlenecks, increase data security through tokenization, and prevent error propagation throughout the system. These and other benefits that can be realized through various embodiments of the present invention will be apparent from the description that follows.

### FIGURES

Various embodiments of the present invention are described herein by way of example in conjunction with the following figures.

FIG. 1 shows a block diagram of a data mesh system comprising a data virtualization platform, according to at least one embodiment of the present invention.

FIG. 2 shows a comparison of a point-to-point data integration system and a data mesh system, according to at least one embodiment of the present invention.

FIG. 3 shows a block diagram of data integration in data mesh system, according to at least one embodiment of the present invention.

FIG. 4 shows a build pattern in the integration layer of the semantic layer on a data virtualization management server, according to at least one embodiment of the present invention.

FIG. 5 shows a first meta-model defining the logical relationships between data management artifacts, according to at least one embodiment of the present invention.

FIG. 6 shows a second meta-model for logical schema deployment of a data dictionary and business glossary showing the relationship between data types, business objects, and service definitions, according to at least one embodiment of the present invention.

FIG. 7 shows a block diagram for a technical approach to convert a non-conforming data object into a conforming data object, according to at least one embodiment of the present invention.

FIG. 8 shows a block diagram of the technical approach for connecting a data source that does not meet data mesh requirements to the data virtualization management server of the data mesh, according to at least one embodiment of the present invention.

FIG. 9 shows a block diagram for on-demand integration using the data mesh system, comprising a plurality of data objects from a plurality of data sources, to a data virtualization platform, according to at least one embodiment of the present invention.

FIG. 10 shows a logical diagram for an on-premises data virtualization deployment for a plurality of clients 1030a-n querying data through a data virtualization platform, according to at least one embodiment of the present invention.

FIG. 11 shows a logical diagram for a hybrid-cloud deployment of data mesh system connecting data from a plurality on-premises and cloud data centers inclusive of on-premises data center, on-premises data center, cloud data center, cloud data center, and cloud data center, according to at least one embodiment of the present invention.

FIGS. 12A-C show a logic flow diagram for on-boarding data objects from a plurality of data sources through an on-demand integration process in a data virtualization platform, according to at least one embodiment of the present invention.

### DESCRIPTION

The present invention describes a data mesh system for on-demand data integration from a plurality of data sources, in a data virtualization environment. Unlike traditional data warehouses or data lakes, the data configured in the data mesh system remains at their original data sources and are not physically moved into a centralized data pool. Instead, the data mesh system uses data virtualization to create a hierarchical connected graph of data views to extract and curate data for consumption, via consumption data views, called data products. The data mesh system creates federated data pipelines between data sources and data consumers. The data pipelines are owned and managed by a data domain (e.g., specific line of business for a type of data) that has deep understanding and knowledgeable about the data objects, thus eliminating knowledge transfer bottlenecks caused by centralized data integration approaches. The data virtualization platform is data integration system (e.g. middleware) using data virtualization technology. The data virtualization platform comprises a connected network of data virtualization management servers. Each data virtualization management server is configured to perform data integration processing using the connected graph of data views to build a plurality of domain-specific data products. The plurality of domain-specific data products may be integrated together to create cross-domain data products. The plurality of domain-specific and cross-domain data products establishes an enterprise data marketplace. The data mesh system does not connect all data from all data sources, rather specific data objects (e.g., a table, a topic, an API, etc.) are selected from data sources to connect to the data mesh in order to fulfill the data requirements of data products. The data objects that provide data to the data virtualization platform must follow stringent data and data obfuscation consistency rules in order to support on-demand data integration in the data virtualization platform. Accordingly, the present invention provides the technical knowhow to create an on-demand data integration platform from a plurality of disparate date sources in a plurality of data formats, maintains data security obfuscation requirements, and reduces the need to physically extract and move data from their data sources.

‘On-Demand’ means data sources are queried at a point in time when a request for data is submitted by the data consumer. On-demand data integration supports data delivery from real-time data sources as well as data sources persisting in data curated environments using a plurality of batch processing methods (e.g., streaming, micro-batch, etc.). On-demand integration requires multimodal data currency to be address in the design of data products. Data from a plurality of data sources being integrated with data mesh may be real-time, near-real-time, micro-batch, or batch. Understanding the data currency of data sources is key when designing data product solutions to ensure data quality. In one example, a data product requires data from two different data sources such as a data warehouse table and a Kafka topic. The data warehouse table contains customer contact information and is updated nightly using batch processing, whereas the Kafka topic contains transaction events and is updated in real-time by a streaming application. When a data consumer submits a query of the data product, the result set will provide some data that is extremely current from the Kafka topic and some data that may be a day old from the data warehouse. During a given day, a customer may update their address and then make three business transactions. In this example, the data mesh system carefully considers the association between old customer information and the three business transactions. One feature of data mesh is to correctly return queries information fora second query request following the nightly batch update of the data warehouse, simulating the intent of Lambda and Kappa architecture approaches.

In one example, the data mesh system may be configured to provide high volume transaction authorization data as a data product, supporting millions of transactions per day and scalable to support higher transaction volume (e.g., scales from 7 million transactions to 14 million transactions). The data mesh system is also configured to support data retention plans such as a 7-year mandatory data retention rule. The data virtualization platform supports a data view of the transaction authorization data for data consumption, including data views for ad-hoc data queries, reporting, dashboards, business intelligence and data analytics. The use of relation data views enables flexibility in how the data is partitioned and the technologies used for various partitions, obfuscating the physical implementation from the consumer. The data virtualization platform enables the transactional authorization data to be physically stored and prioritized by age. The data is configured such that current data is persisted on expensive, high-speed technology and older data is persisted on less expensive, slower technology (e.g., high-speed MPP for high demand data and slower-speed Object Store for less frequently used data). Data virtualization enables the logical union of the data across various technologies using data views to provide a single view of the transaction authorization data to consumers while permitting various storage technology to be leveraged to achieve optimized cost and performance objectives. Performing data consistency, obfuscation consistency, and data organization tuning for performance at the data source, prior to being configured in the data virtualization platform, allows on-demand data integration while eliminating data processing steps such as data replication and transformation.

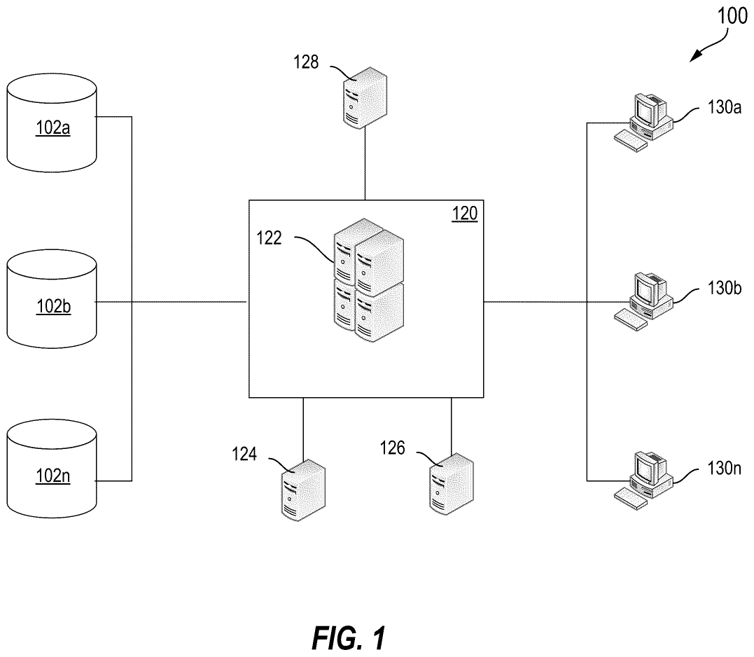

FIG. 1 shows a block diagram of a data mesh system 100 comprising a data virtualization platform 120, according to at least one embodiment of the present invention. The data virtualization platform 120 further comprises a solution manager server and multiple virtual data port servers, the data virtualization management server 122, configured to deploy the data mesh system 100. The data virtualization management server 122 is configured to receive data objects from a plurality of data sources 102a-102n (e.g., SQL, MongoDB, Oracle, Hadoop, Kafka, etc.) and integrates those data objects on-demand to provide a contiguous data interface for resulting data to a plurality of clients 130a-130n. The data virtualization management server 122 may be configured to manage data integration from the plurality of data sources 102a-102n, converting native data formats of data sources to a common, flattened data view. The data mesh system 100 minimizes data duplication and reduces query processing strain on the plurality of data sources 102a-102n from M×N integration paths to M+N integration paths, significantly reducing development, maintenance, data processing, and data storage cost.

Additionally, the data mesh system 100 includes a schema management server 124 (e.g., ERWIN), a data catalog management server 126 (e.g., ALATION), and a security information and event management (SIEM) management server 128 (e.g., SPLUNK). The schema management server 124 (e.g., ERWIN) may be configured to manage schemas for a plurality of semantic views used to convert a plurality of data sources 102a-102n to data products consumed by a plurality of clients 130a-130n. The schema management server 124 may be used by a plurality of clients 130a-130n to ensure schema consistency with a plurality of data products used by a plurality of clients 130a-130n for reporting, business intelligence (BI), and analytics. The schema management server 124 may be configured to reduce schema build work effort, minimizes inconsistency in schema definition across tools and applications permitting consumers to change tools at much lower conversion cost and less impact to business process.

The data catalog management server 126 (e.g., ALATION) may be configured to manage schema definition of data views configured in the semantic layer used to convert a plurality of data sources 102a-102n to data products consumed by a plurality of clients 130a-130n. The data catalog definition is inclusive of business term definition, technical definition, and metadata classification tags (e.g. CISO TAGS, CDO TAGS, etc). The data catalog information, exported to the data catalog management server 126, may be used to enhance searches, analyze metadata, and enable reuse of data.

A security information and event management (SIEM) management server 128 (e.g., SPLUNK) may be configured to understand data access patterns and to detect data security threats before they disrupt business. The understanding of data access patterns is a primary input to CTO data fabric decisions regarding the locality of data and the organization of data across multiple storage technologies, having various cost and performance profiles.

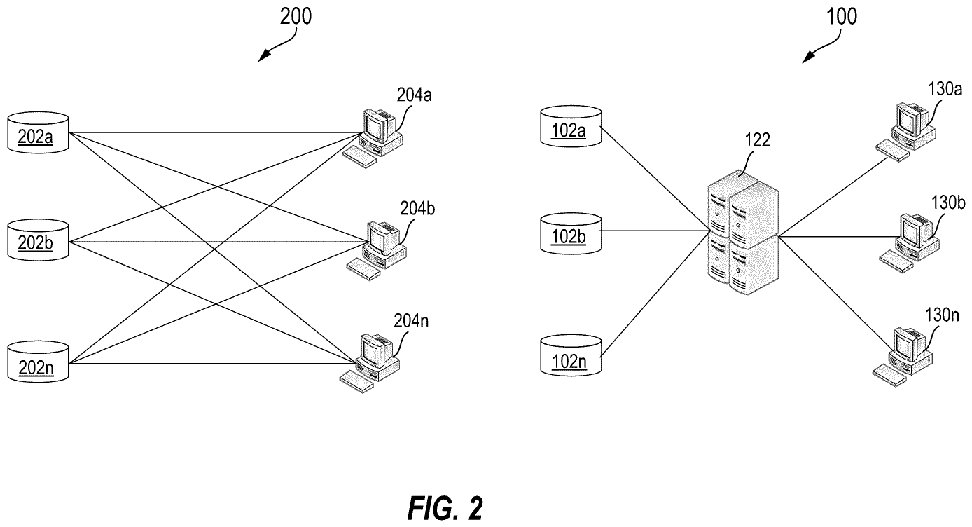

FIG. 2 shows a comparison of a point-to-point data integration system 200 and a data mesh system 100, according to at least one embodiment of the present invention. The point-to-point data integration system 2000 comprises a plurality of point-to-point integration paths between each of the data sources 202a-n and a plurality of data consumers 204a-n. The number of integration paths in the point-to-point data integration system 200 is determined by the number of data sources, M, multiplied by the number of data consumers, N. The data mesh system 100 comprises a data virtualization platform 122 that enables a publish-subscribe integration model between a plurality of data sources 102a-n and a plurality of data consumers 130a-n. The number of integration paths in the data mesh system 100 is determined by the number of data sources, M, added to the number of data consumers, N. The data mesh system 100 has a number of advantages over the traditional data management system 200 including more storage capacity, minimized attach surface, improved data locality, reuse, and data access visibility. Furthermore, Table 1 shows a comparison of the integration paths in the point-to-point data integration system 200 compared to the data mesh system 100. As shown by examples in the table below, the data mesh system 204 exponential reduces the number of integration paths.

Integration Paths

| Data | Point-to-point | Data mesh | Data |
|---|---|---|---|
| Sources | system 200 | system 100 | Consumers |
| M = 3 | M × N = 9 | M + N = 6 | N = 3 |
| M = 10 | M × N = 100 | M + N = 20 | N = 10 |
| M = 100 | M × N = 10000 | M + N = 200 | N = 100 |

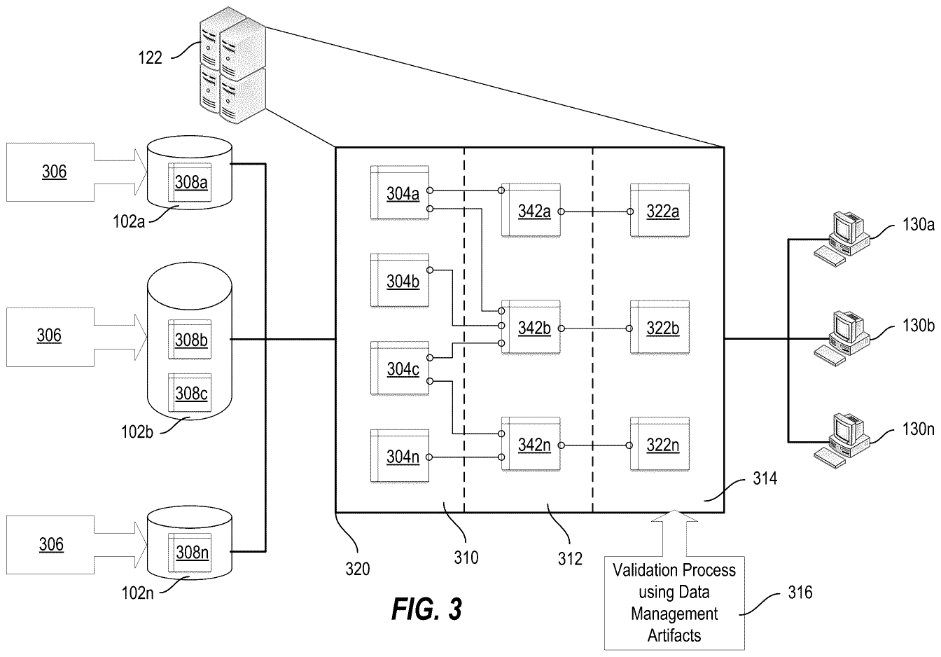

FIG. 3 shows a block diagram of data integration in data mesh system, according to at least one embodiment of the present invention. The data virtualization management server 122 comprises a plurality of semantic layers 320 including a base layer 310, an integration layer 312, and a consumption layer 314, configured to provide data products to the data customers 130a-n. Data flows from the plurality of data sources 102a-102n to the base layer 310 to the integration layer 312 to the consumption layer 314. The data mesh system uses a hierarchical connected graph of data views ‘schemas’ defined in the semantic layers allow for on-demand integration of conforming data objects without the need to physically move data to a data warehouse using traditional methods such as ETL (extracting, transforming, and loading). The semantic layer 320 virtually integrates data that is siloed across disparate systems (e.g., data sources 102a-102n) while providing centralized security, governance, and management capabilities to make data available to business users on-demand.

The base layer 310 is configured to connect the plurality of ‘data-mesh ready’ physical data objects 102a-n to the data virtualization platform 122. The data objects 102a-n are atomic objects (e.g., a table, a topic, a data stream, a parquet file) that are highly curated to adhere to a data mesh onboarding guide of the enterprise and/or enterprise data standards. The data virtualization platform does not perform data manipulation operations (e.g., MERGE, UNION, SUM, AVERAGE, JOIN) in base layer data view queries for the retrieval of data from a data objects 102a-n to promote performance and reuse. Additionally, base layer data view queries should not be configured to query complex views on the data objects 102a-n containing data manipulation operations (e.g., data source views that contain operations such as merge, union, aggregation). Using atomic data views improves query optimization and allows base views to be used to deliver multiple data product use cases with varying data requirements. Also, each data object is aligned to one and only one base layer data view to minimize query impacts on the data source and to eliminate inconsistencies that may be introduced if multiple base layer views queries retrieve the same data from the same data source.

The integration layer 312 allows for on-demand integration of data views 304a-304n that have been defined in the base layer 310. Integration data views 342a-342n are configured in the integration layer to perform all integration and data manipulation steps needed to manufacture and curate a data product by querying base layer data views 304a-n to retrieve data from data objects 102a-n. Integration data views are a hierarchical connected graph of data views used to manipulate data retrieved form base views using data manipulation operations such as JOIN, MERGE, UNION, Filtering, Grouping, Aggregation (e.g., SUM, AVERAGE, etc.), and other data manipulation operations (e.g., multiple integration data views may be needed join data at several differing levels of granularity).

The consumption layer 314 abstracts the details and mechanics of integration and data retrieval from the client. The consumption data views 322a-n are configured to query data from one or more integration data views. The consumption data views 322a-n (e.g., ‘data products’) are the objects that clients connect to in order to perform adhoc-query, reporting, business intelligence and analytics. The data mesh system allows for change in underlying integrations and data sources without impacting the clients, because the clients are isolated from underlying logic, technologies and data locality.

The semantic layer 320 is built using composable data architecture approach. Data products are designed and built by assembling independent, self-contained, and interchangeable data components called micro data services that are used as data building blocks. Each data view provides a specific purpose, has well-defined boundaries, and should not be overlapping. The semantic layer data views may be connected or stacked in a multitude of arrangements to create a plurality of data products with the same set of data views, micro data services, by organizing them differently in a connected graph to fulfill multiple business data requirement needs.

All data objects connected to the semantic layer 320 must conform to associated technical definitions documented or data consistency rules in the enterprise data dictionary (EDD), the enterprise data quality rules (EDQ), and CISO Tokenization/Obfuscation standards (STS). The base layer 310 comprises data views 304a-n whose purpose is to retrieve data from conforming data objects 308a-n in a one-to-one relationship (e.g., files, tables, topics, etc.).

Before the plurality of data sources 102a-102n can be connected to the base layer 310, a first technical verification process 306 determines a data conformity status or verifies that the data objects 308a-n conform with the holistic set of data quality, data consistency, data obfuscation rules, technical guidelines, and technical data patterns, outlined in a data mesh onboarding guide (e.g., Data Mesh and Data Product Onboarding Guiding Principles) and enterprise data standards. These guides and standards ensure data security, data consistency, high performance, and integration readiness across all inputs to the data mesh system 100 and throughout the semantic layers 320. All data mesh components of the data mesh system 100 must adhere to enterprise data standards to ensure consistency, where the enterprise data standards comprise: business glossary (EBG), semantic modeling rules (ESM), CDO tagging classifications (data element, data product), reference data (ERD), technical data architecture patterns, technical development guidelines and best practices, data dictionary (EDD), business event catalog (BEC), data quality rules (EDQ), CISO tagging classifications (for data elements or data products), CISO Tokenization/Obfuscation standards (STS).

Before the plurality of data sources 102a-102n can be connected to the base layer 310, all nonconforming data sources, identified by the technical verification process 306, must be resolved. Once the technical verification process 306 determines that the data objects 308a-n meet the holistic requirements for data mesh system 100, the data objects are determined to be ‘conforming data objects’ and are connected to the semantic layer 320 of data virtualization platform 122 at the base layer 310 using data views 304a-304n. The invention relies on data consistency throughout all connected data objects 308a-n and the semantic layers 320 as a necessary requirement to perform the on-demand data integration. The enterprise data standard artifacts and the data mesh onboarding guide (e.g., Data Product Onboarding Guiding Principles) may be maintained as living documents that are embellished over time as data products are onboarded to the data mesh. All enterprise data standard artifacts and the data mesh onboarding guide (e.g., Data Product Onboarding Guiding Principles) are reviewed and updated as part of the data product delivery process before development occurs. As an example, data object the development teams prepare the data objects 308a-n for the base layer 310 based on guidance from the technical data architecture patterns, technical development guidelines, and best practices to prepare or transform nonconforming data objects 308a-n for the data mesh system. One such guideline is to use integer surrogate keys for non-integer business keys that will be used for integration by data consumers and the use of horizontal and vertical data partitioning strategies, based on data access patterns. In addition, data objects must adhere to semantic modeling rules and schema data element definition must adhere to data dictionary rules. For example, the semantic modeling rules may define how to handle null values and overloaded data elements (e.g., a given data element will have multiple potential meanings).

The data mesh system prepares data for consumption at the data source rather than at the data virtualization platform. By preparing the data at the data source, the data virtualization platform eliminates significant data processing overhead that will otherwise occur during each query of a data product.

All schema data elements associated with the data views, configured in the semantic layer 320, must conform to associated technical definitions documented in the enterprise data dictionary (EDD). The data views of the semantic layer 320 are configured using SQL syntax to query lower-level data views or data objects. The semantic layer 320 is built using composable data architecture approach. Data products are designed and built by assembling independent, self-contained, and interchangeable data components (e.g., micro data services used as data building blocks). Each data view provides a specific purpose and has well-defined boundaries and should not be overlapping.

The purpose of base layer 310 data views 304a-n is to retrieve data from data objects 308a-n on data sources 102a-n. The integration layer data views 342a-n retrieve data from base layer 310 data views 304a-n, and/or integration layer 312 data views 342a-n and perform transformations to prepare the data for consumption. The consumption layer 314 data views 322a-n retrieve data from the integration layer data views 342a-n, and/or the consumption layer data views 322a-n and prepare integrated data for consumption. The consumption layer 314 data views 322a-n are used to deliver data ‘data products’ to data consumers.

The base layer 310 comprises data views 304a-n. The base layer data views are configured to retrieve data from corresponding data objects 308a-n that reside on data sources 102a-n. Data retrieve from data objects 308a-n by base layer data views must be immutable and unaltered (e.g., a mirror of the data object) to support multiple use cases as well as extensibility as data requirements change over time. Additionally, data views 304a-n should be configured to include all data elements of the corresponding data objects 308a-n to provide flexibility in supporting multiple use cases as well as extensibility as data requirements change over time. The base layer data views 304a-n should not introduce transformation, substitution, filtering, grouping, aggregations, nor other data manipulation options that change source data. The base layer data views 304a-n should not be stacked in a hierarchy to perform any type of transformation operation such as aggregation or combining data from multiple base layer data views 304a-n as this practice would constitute an integration processing step. The job of base views is to retrieve data from data sources. Data retrieved by base layer data views must meet the holistic set of rules for data quality, data consistency, data obfuscation, technical guidelines, and technical data patterns, outlined in the data mesh onboarding guide (e.g., Data Mesh and Data Product Onboarding Guiding Principles) and enterprise data standards, to ensure data security, data consistency, high performance, and integration readiness.

The integration layer 312 comprises data views 342a-n. The integration layer data views 342a-n are configured to combine and prepare data retrieved from one or more base layer data views 304a-n for consumption. The integration layer 312 is where transformation and business logic are applied to meet the data requirements of the data product use case. Each integration layer data view 242a-242n provides a specific purpose and has well-defined boundaries. The functions performed by the integration layer data views 242a-242n are constructed to promote as much parallelism as possible for that data processing can be distributed as much as possible across the distributed data virtualization platform 122. Data transformation and business logic are applied in the integration layer 312 by configuring a dataflow through a series of integration data views. The sequence of data manipulation operations used to prepare data for consumption within the integration layer 312 is important to achieve high performance, these integration patterns are tested and documented in the technical development guidelines and best practices artifact and repeatably used to achieve consistency and performance. For example, when retrieving data from multiple base layer data views 304a-n integration steps should be generally followed using the proven integration pattern a) filter data retrieved from base layer data views 304a-n to reduce the breadth and depth of the data sets returned from the underlying data objects 308a-n to minimize data source and network utilization, b) combine integration views 342a-n that are of the same granularity using surrogate keys, c) establish a common data granularity by grouping and aggregating (e.g., get all authorization transactions to the market or region level), d) combine integration views 342a-n having the common granularity using surrogate keys, e) apply transformation, aggregation and business logic to achieve the use case business requirements for the data product use case. The data mesh system employs the following principles for data integration: a) use a composable data architecture approach for designing data views b) reduce data sets as much as possible before performing data processing (e.g., aggregations, transformations, etc.), and c) design for parallelism, therefore keeping the purpose of data views very specific.

In various embodiments, the enterprise data standards are applied, including semantic modeling rules on the physical data objects 308a-n, to eliminate data processing overhead cause by repeated execution of rules to fix non-compliant data within the integration layer 312. Data issues should be fixed once at the data object 308a-n and not in the integration layer to achieve operational efficiencies.

The consumption layer 314 comprises data views 322a-n. Consumption layer data views 322a-n are configured to present and distribute data retrieved from one or more integration layer data views 342a-n to data consumers. Consumption layer data views 322a-n provide a) a single point of data access for security authorization, b) isolation and abstraction from underlying data, software, integration, and infrastructure, c) a means to tailor the presentation of data from integration data views for multiple data customer constituents, d) one input to multiple data delivery channels. The data mesh system uses multiple levels of data security authorization a) data consumers must be authorized to access the platform, b) data consumers must be authorized to access specific consumption layer data views, and c) data consumers must be authorized to access the underlaying data objects 308a-n to which the base layer data views are connected. The data mesh system is configured so that the data consumers 130a-n retrieve data from consumption data views only, never from underlying integration data views 322a-n and base data views 304a-n. This configuration provides a level of abstraction, insulating data consumers 130a-n from upstream changes to integration logic, base layer connectivity to data sources and data objects, changes to data sources 102a-n and data objects 308a-n, data source technology changes, and data organization and locality changes, etc. This practice frees data, software development, and infrastructure teams to make changes with minimal impact to downstream data consumers. Consumption data views 322a-n retrieve data from a subset of integration views 342a-n that is consumption ready, these integration data views are typically the top-most integration data views in data pipelines instantiated in the integration layer 312. Multiple consumption data views can retrieve data from the same integration view to customize data products for multiple data consumers. This customization may include a) a subset of data elements, b) a customer order of data elements, c) additional aggregation specific to a subset of data consumers. Additionally, a consumption view can be created to retrieve data from more than one consumption view to create new data products. For example, combining authorization transactions from multiple lines of business to form an enterprise view of authorization transactions.

Before the plurality of data consumers 130a-n can connect to the consumption data views 322a-n of the consumption layer 314, a second technical verification process 316 verifies that the data views created in the semantic layer 320 conform with the holistic set of data quality, data consistency, data obfuscation rules (e.g., data security rules), technical guidelines, and technical data patterns, outlined in the data mesh onboarding guide (e.g., Data Mesh and Data Product Onboarding Guiding Principles) and enterprise data standards, to ensure data security, data consistency, high performance, and data preparation for consumption. All data elements that do not conform with these guides and standards must be resolved before a consumption view can be accessed by data consumers.

As part of the data product data preparation process, schemas associated with new or updated data views and all associated schema elements in the semantic layer 320, built on the data virtualization platform 120, must have complete documentation to enable search, understanding, and reuse by data consumers and development teams. All documentation is captured as metadata in the data catalog is maintained by the data virtualization management server 122. All data view schemas are captured as metadata in the schema repository and maintained by the data virtualization management server 122.

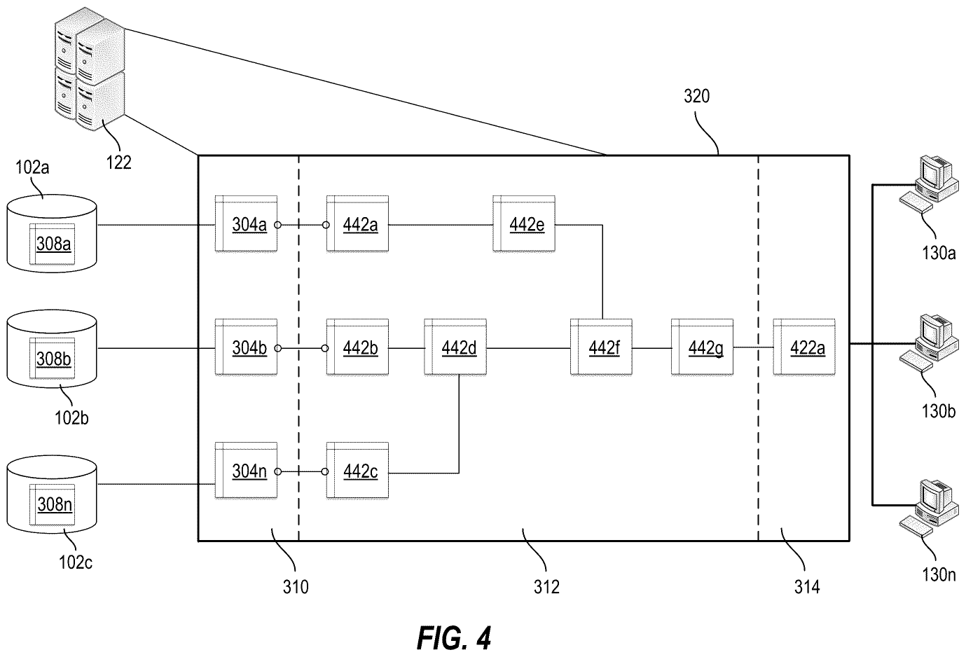

FIG. 4 shows a build pattern in the integration layer 312 of the semantic layer 320 on a data virtualization management server 122, according to at least one embodiment of the present invention. The integration layer 312 performs the build pattern with a plurality of integration layer data views 442a-g, where 442a-c correspond to filters. The filter data views 442a-c receive queried data from the base data views 304a-n and filter data views 442b-c may be combined into 442d. The filtered data view 442a may undergo further processing to establish a common data granularity at data view 442e before it is combined with combined data view 442d at a second combined data view 442f. Prior to passing the data to the consumption view 314, the second combined data view 442 applies and transforms data aggregation and business logic at the processed data view 442g.

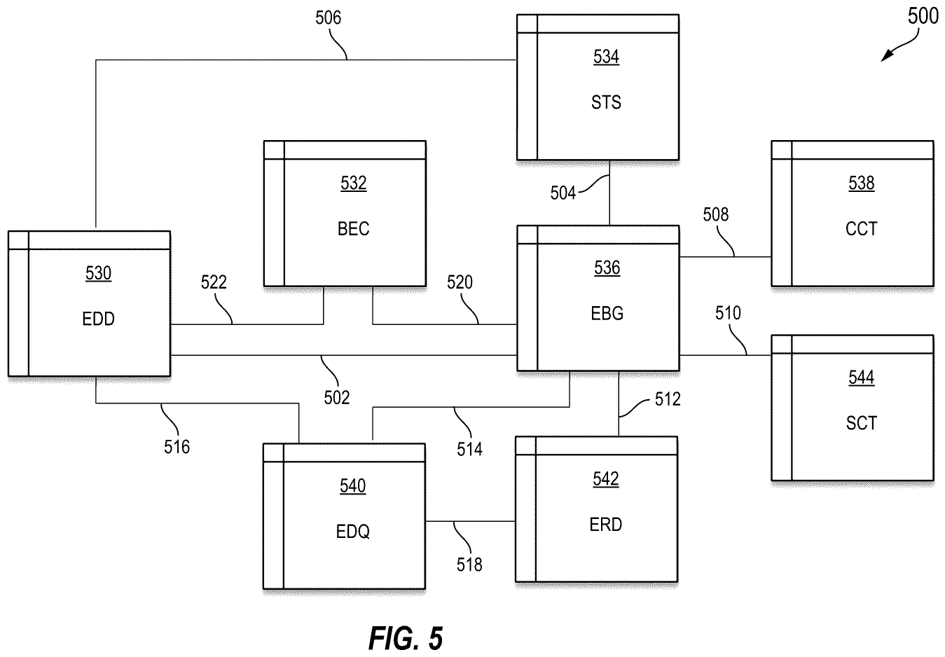

FIG. 5 shows a first meta-model 500 defining the logical relationships between data management artifacts 530-544, according to at least one embodiment of the present invention. The data management artifacts 530-544 may be used to govern data objects 308a-n being connected to the data virtualization management server 122 of the data mesh system 100. The EBG 536 is central to other data management artifacts that are needed to build and maintain a high performing data mesh system 100. The data management artifacts comprise enterprise business glossary (EBG) 536, the data dictionary (EDD) 530, reference data (ERD) 542, data quality rules (EDQ) 540, CDO classification tagging (CCT) 538, CISO classification tagging (SCT) 544, CISO tokenization/Obfuscation standard (STS) 534, and business event catalog (BEC) 532, all these data management artifacts refer to the EBG 536 business term. The EBG 536 is the information source for all data semantics for the data mesh system 100 and ensures data semantics are consistently applied to schemas across data objects 308a-n and the semantic layer 320 that constitute the data mesh system 100. Data consistency facilitates ease in performing data integration and minimizing risk of erroneous data integration. The EBG 536 drives consistency in use of business team names, synonyms and definition.

The EBG 536 is built top-down starting with enterprise level definition to business line definition to department definition. The business line and department definitions must adhere to the higher-level definitions to maintain consistency. However, high-level definition may be supplemented by setting further restrictions (e.g. a business line may choose to use fewer valid codes defined for a business term at the enterprise level). At the business line level, the business glossary may contain business terms and definitions only used by a specific business line, providing common understanding as business lines may use semantics that are specific to their business and/or business processes. When a business term is used by more than one business line, it is re-classified as an enterprise business term. Consistency is always maintained in the business glossary through definition inheritance from enterprise to lower levels, a requirement is that a lower level cannot violate definition from higher levels (e.g., add a code not approved at the enterprise level). Inheritance enables the business glossary to support an ontology to address semantic variations that are natural in business across business lines and departments.

FIG. 5 further shows a plurality of relationships defined by the first meta-model 500, for managing data semantics across all semantic layers. A first relationship 502, between the EBG 536 and the EDD 530, defines a relationship for a glossary term that has a dictionary definition, and a dictionary definition that has a glossary term. A second relationship 504, between the EBG 536 and the STS 534, defines a relationship for a glossary term that may need to be tokenized. A third relationship 506, between the STS and the EDD 530, defines a relationship for a tokenized term that requires a dictionary definition for consistency. A fourth relationship 508, between the EBG 536 and the CCT 538, defines a relationship for a glossary term that may have 0 or more CDO classification tags. A fifth relationship 510, between the EBG 536 and the SCT 544, defines a relationship for a glossary term that may have 0 or more CISO classification tags. A sixth relationship 512, between the EBG 536 and the ERD 542, defines a relationship for a glossary term that may have associated reference data. A seventh relationship 514, between the EBG 536 and the EDQ 540, defines a relationship for 0 or more data quality rules that may be defined for a glossary term. An eighth relationship 516, between the EDQ 540 and the EDD 530, defines a relationship for 0 or more data quality rules that may validate the technical definition of a glossary term. A ninth relationship 518, between the EDQ 540 and the ERD 542, defines a relationship for data quality rules that may use reference data for validations. A tenth relationship 520, between the EBG 536 and the BEC 532, defines a relationship for business event data elements that must have a business definition. An eleventh relationship 522, between the EDD 530 and the BEC 532, defines a relationship for business event data elements that must have a technical definition.

All schema elements associated with data views configured in the semantic layer 320 must conform to associated technical definitions documented in the enterprise data dictionary (EDD). Referencing the EDD fosters understanding of technical aspects of data views such as valid values, ranges, limits, and promotes understanding and reuse. Standardize business terms are assigned to all schemas and schema elements configured in the data views built in the semantic layer 320 using the enterprise business glossary (EBG). CDO and CISO classification tags ‘labels’ are assigned to all relevant schemas and relevant schema elements configured in the data views built in the semantic layer 320 using the CDO and CISO classification tags documented in the enterprise business glossary (EBG). CDO and CISO classification tags enable the identification of schema elements associated data privacy (e.g., GDPR, CCPA, HIPAA), personally identifiable information (PII), and data security classification. Ensuring classification tags are part of each data view schema definition and its schema documentation aids understanding, search, and reuse. Classification tags also aid with security information end event management (SIEM) monitoring analysis performed by the SIEM management server 128. Schemas associated with new or updated data views in the semantic layer 320, built on the data virtualization platform 120, must have complete lineage documentation regarding the sources of data being retrieved by data views by referencing the Business Event Catalog (BEC). Ensuring that business event data made available via the data mesh are retrieved from CDO sanctioned data sources will promote understanding, trust, and reuse. Schemas associated with new or updated data views in the semantic layer 320, built on the data virtualization management server 122, must have complete documentation regarding schema element obfuscation so that data consumers and developers know the specific schema elements that have been obfuscated. Schema elements of data views are obfuscated in accordance with CISO Tokenization/Obfuscation standards (STS) (e.g., data security rules). The obfuscation algorithms should not be documented as part of schema element documentation. Data consumers and developers requiring knowledge of the obfuscation algorithms may submit a CISO request for information.

All schemas associated with new or updated data views must be exported from the data virtualization management server 122 to the schema management server 124 (e.g., ERWIN) for utilization by data consumers in reporting, business intelligence (BI) and Analytic tools. All schema and schema element metadata definitions associated with new or updated data views, captured in the data catalog, must be exported from the data virtualization management server 122 to the enterprise data catalog management server 126 (e.g., ALATION) for utilization by data consumers for search and reuse.

All schema and data catalog information maintained by the data virtualization management server must be exported to the enterprise data catalog 126 and schema 124 management to allow for all enterprise data consumers to search and understand what data products are configured in the data virtualization platform 320 of the data mesh 200.

The data mesh system uses an enterprise business glossary (EBG) 536 and enterprise data dictionary (EDD) 530 to drive data consistency, help find, understand and use data, and reduce the cost of data quality, data obfuscation, development, and data integration. CDO and CISO classification TAGs are included as part of the business term definition in the EBG. The EBG provides the ‘Semantics of Data’, clear enterprise-wide business definitions with the goal of keeping business terms consistent and promoting understanding, correct use and reuse. Business lines may use the same term (e.g., Profit, Non-Operating Revenue, Net Income) however definition may be inconsistent across business lines. Additionally, business lines may each use different business terms but having the same business definition ‘synonyms’ (e.g., Profit, Net Income, Earnings). The EBG 536 ensures data semantics are consistently applied to schema across the data objects 308a-n and semantic layer 320 that constitute the data mesh system 100 which facilities ease in data integration and minimizes risk of erroneous data integration.

The EDD provides the ‘Structure of Data’, the detailed technical definition of each business term found in the business glossary taxonomy. The EDD ensures that a data structure is consistently applied to schema across the data objects 308a-n and semantic layer 320 that constitute the data mesh system 100 which facilities ease in data integration. Applying the EDD to the data objects 308a-n and semantic layer 320 that constitute the data mesh system 100 eliminates significant data processing overhead that would otherwise be required to homogenize like business terms from disparate data objects prior to performing integration, during each query execution. The data mesh system may implement a one-to-one relationship between entries in the EBG and EDD. All data elements defined in the data dictionary must have an assigned business term and vice versa. Data glossary terms may have additional definition including CDO classification tags, CISO classification tags, reference data (e.g., county codes, product codes), and data quality rules. Data quality rules may also be defined to validate technical definition (e.g., minimum, maximum, ranges, regular expression conformance).

In one example, the EBG may consist of a documentation pattern that is divided into sections:
1. Naming Rules
2. List of Abbreviations
3. List of Codes
4. List of Indicators
5. Glossary of Terms
   The Glossary of Terms is further divided into sub-sections:
5.1 Glossary Term—The key entry in the business glossary. It is a business concept or entity identified by a unique name and defined by a meaningful description
5.2 Definition—Explanation and specification of a concept/entity understandable by both business and technical users
5.2.1 Short Definition
5.2.2 Long Definition
5.3 Glossary Term Relationships—Relationships between the terms, policies, and rules
5.3.1 Calculated from
5.3.2 Replaced by
5.3.3 Is modifier of
5.3.4 Related terms
5.4 Data Domain—What data domain does this term relate to
5.6 Business Category—What part of the enterprise does this information belong to?
5.7 Aliases/Synonyms/Abbreviations—A list of other names and abbreviations this term is also known under as business lines many use differing terminology
5.8 Owner/Steward—Person responsible for the process of gathering information, agreeing on the definition between all stakeholders and publishing the term
5.9 Status—Indicate the stage of the definition of the term in its lifecycle, i.e., Suggestion, Draft, Pending Approval, Approved, Deprecated
5.10 CISO Classification—Data Security classification of the term in the form of Standard TAGs, i.e., PII, PHI, HIPAA, PCI DSS, PAN, etc.
5.11 CDO Classification—Data Security classification of the term in the form of Standard TAGs, i.e., CCPA, GLBA, etc.
5.12 Business rule—Data governance rules
5.13 Policy—Policies that define how, where and by whom data will be managed

The enterprises data dictionary (EDD) is the information source for detailed technical definitions of business terms found in the enterprise business glossary (EBG). The data dictionary is used to ensure federated technical groups across an enterprise use consistent technical representations for data as they prepare and build data objects 104a-104n and the semantic layer 320 that constitute the data mesh system 100. The EDD 530 defines the technical data attributes for EGB business terms, including constraints, data types, default values, length, range, minimum, maximum, and all other technical data attributes associated with a business term. The EDD 530 is used in the data mesh system 100 to drive technical data consistency through consistent and highly prescribed data definition, this imposed rigor results in lowering the cost of data integration, data tokenization, and data quality efforts. Within the EDD 530 a naming convention must be establish for data to maintain data continuity, it also assists in driving understanding and reuse as data objects and schema are built. If abbreviations are permitted, standard naming conventions for abbreviations must be defined. The EDD 530 is designed top-down to ensure consistency through inheritance much like the EBG. In one example, the EDD may define a documentation pattern that is divided into sections, such as 1. Data Types, and 2. Business Objects.

1. Data Types are defined bottom up through inheritance from most atomic ‘general’ to higher order representations.

1.1 Atomic Data Types (ADT) is based on an industry data standard such as World Wide Web Consortium (W3C), specifies how to formally describe data elements in an extensible markup language (XML) document. ADTs a) includes both primitive and complex data types, b) have no business semantics, c) are defined usage-neutral, and d) map to the physical, a cross reference to data types in languages, databases, etc. Examples include: Boolean, Date, Time, DateTime, Integer, Double, Decimal, Float, String, and BooleanList. Each ADT defines its physical implementation in various data technologies and ensures consistency in the physical implementation of data types. For example, Teradata, Oracle, MongoDB and Snowflake may use different syntax for a Boolean representation. Each ADT must provide clear instruction for physical implementation by technology.

1.2 Foundational Data Types (FDT) are higher order data type representations that define general usage data types such as Indicator, Code, Amount, etc. FDTs are derived from ADTs. FDTs a) include both primitive and complex data types, b) use no business semantics and are defined usage-neutral, and c) build additional context by defining use, structure, description, value ranges, length, integrity conditions, examples, etc. Examples FDT of data types include: Amount, BinaryObject, Code, Indicator, Measure, Numeric, Name, LocalDateTime, and IndicatorList. FDTs can be compound data structures. For example, a Numeric FDT may be an ADT Decimal with a ADT Boolean to indicate positive or negative, a CurrencyCode FDT may be a may be a 3 byte ADT String, the Amount FDT is a Numeric monitory amount with the corresponding CurrencyCode for currency unit (e.g., 10, Euro]), and Measure data type is a Numeric physical measurement with the corresponding unit of measurement Code and a String Code qualifier, such as age, distance, height, etc. (e.g., [10, Feet, Height])

1.3 Global Data Types (GDT) are higher order data type representations that are derived from FDTs. GDTs carry business semantics/business acumen; however, they are defined usage-neutral and can be used globally across all business processes and services. GDTs define global business representations but are not business line nor business process specific. GDTs a) includes both primitive and complex data types, b) include business semantics, defined usage-neutral, and c) build additional context by defining use, structure, description, value ranges, length, integrity conditions, examples, etc. Examples of GDTs include Address, ProductId, CustomerID, etc. GDTs can be compound data structures, for example Address.
2. Business objects are defined using the sub-sections
2.1 Data Type Name(header)
2.2 Status/Owner
2.3 Definition
2.3.1 Comment
2.3.2 Dictionary Entry Name
2.4 Example (Instance)
2.5 Structure
2.6 Detailed Description and Value Ranges
2.7 Integrity Conditions
2.8 Use
2.9 Notes
2.10 Appendix—Code Lists
2.11 Appendix—Qualifier List

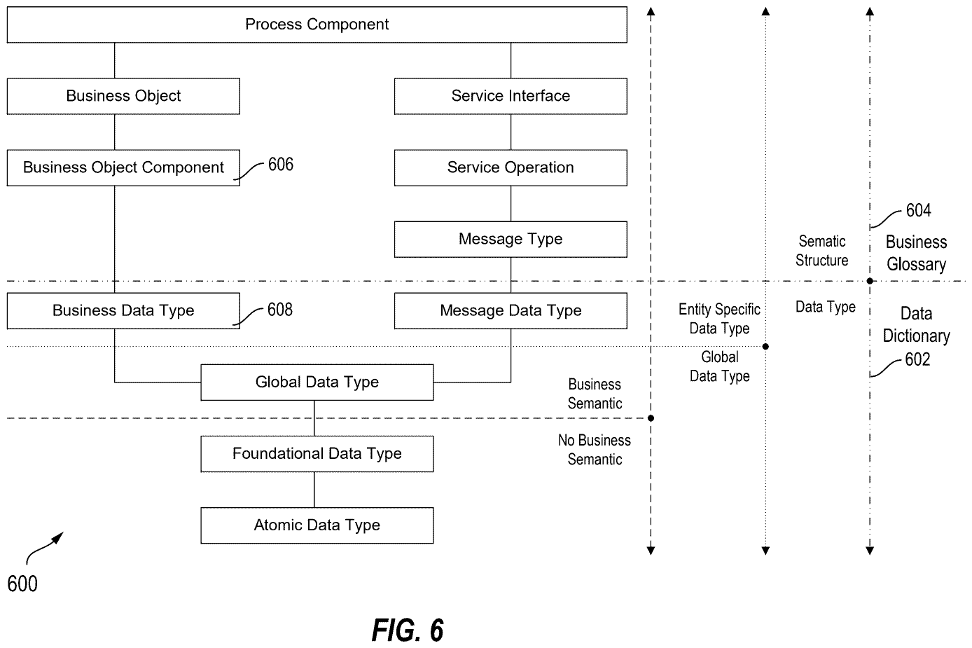

FIG. 6 shows a second meta-model 600 for logical schema deployment of a data dictionary 602 and business glossary 604 showing the relationship between data types 632, business objects, and service definitions, according to at least one embodiment of the present invention. The invention uses the second meta-model 600, implemented in a database, to capture business glossary (EBG) 604 and data dictionary (EDD) 602 definitions used to build all data components of the data mesh system 100. The second meta-model 600 links business glossary terms, ‘Business Object Component’ 608, to data dictionary technical definition, ‘Business Data Type’ 608. The implementation of the second meta-model 600 provides a business and technical definition for every data element of data objects 308a-n and data views built in the semantic layer 320 of the data mesh system 100. The definitions of the second meta-model 600 are used during implementation to ensure data consistency across data objects 308a-n being configured in the data mesh system 100 and data views built in the semantic layer 320.

Semantic metadata provides an understanding of what has been built and configured in the semantic layer 320 of the data mesh system 100. The data virtualization management server 122 maintains an internal data catalog containing the semantic layer metadata documenting what has been built to drive reuse of views created in the base 310, integration 312, and consumption 314 layers. The invention captures a plurality of semantic metadata for each data element that includes business term definition, technical definition, reference data values, data quality rules, CDO classification tags, CISO classification tags, a tokenization/obfuscation indicator, data sources, and lineage. The data catalog internal to the data virtualization management server 122 represents what has been built for use and can be searched and navigated by data mesh system 100 users. The data catalog management server 126 is configured to import the semantic metadata maintained in the internal data catalog of the data virtualization management server 122. All metadata regarding all views built in the semantic layer 320 of the data mesh 100 are exported to the data catalog management server 126. The internal data catalog is exported to the enterprise data catalog that resides on the data catalog management 126 server for use by all enterprise users, hence allowing non-data mesh users aware of data products that are available on the marketplace. The data catalog management server 126 provides a search function over the plurality of captured semantic metadata to enable reuse of data views built in the semantic layer 320.

The data virtualization management server 122 maintains internal schema definitions of all base views 310, integration views 312, and consumption views 314 built in the semantic layer 320. The schema management server 124 is configured to import the internal schemas of data views built in the semantic layer 320 on the data virtualization management server 122 of the data mesh system 100. The schema management server 124 provides a recovery functionality for the schemas if become corrupt, the schemas can be recovered from the data schema management server 124. Exporting the schema of consumption layer data views 322a-n has additional utility as it accelerates the build of semantic configuration in 3^{rd} party reporting, business intelligence (BI) and analytic tools connecting to the data mesh system 100 requiring this configuration. In addition of minimizing semantic definition across a plurality of tools and applications connecting to data consumption data views 322a-n, importing the schema into 3^{rd} party tools minimizes the risk of inconsistent schemas being built and used. Additionally, since the schema definition of data consumption data views 322a-n are consistent across 3^{rd} party tools, users of those tools can more easily be migrated across the plurality of tools and applications connecting to data consumption data views 322a-n.

The data mesh system may configure certain data elements into data views of the semantic layer 320, based on assigned classification tags. The classification tags aid in identifying data elements that have significance to the CDO or CISO functions. A data element may be assigned more than one classification tag and may be assigned a mix of both CDO and CISO classification tags to promote understanding. Classification tags may aid in performing back-office business processes such as SIEM monitoring and the fulfillment of regulatory requirements of various privacy acts, such as California Consumer Privacy Act (CCPA). Data elements that constitute the data views of the semantic layer 320 must be consistently assigned CDO and CISO classification tags, per documented standards, as the data views are created and modified. The invention enables both the internal data catalog maintained by the data virtualization management server 122 and the data catalog management server 126 to be used to search configured schemas of data views for data elements that have been assigned CDO and CISO classification tags. Additionally, lineage metadata collected by the invention may be used to identify the plurality of data sources 102a-102n used to source content of data elements assigned classification tags. Technical and operational metadata collected by the invention may be used to identify consumers and their consumption characteristics (e.g., when, where, what, etc.) of data retrieved using the invention.

Chief Data Officer (CDO) classification tags (CCT) (e.g., data element tags, may characterize a data element of the semantic layer 320 with a data management and governance perspective, such as, line-of-business specific usage (e.g., asset management group, retail, bank operations, lending services, strategic services, mortgage, corporate and institutional banking services, anti-money laundering, capital markets, finance, risk). In one example, CDO classification tags for consumer protection regulations may identify a data element as being applicable to or regulated under the California Consumer Privacy Act (CCPA), Gramm-Leach-Bliley Act (GLBA), General Data Protection Regulation (GDPR), Health Insurance Portability and Accountability Act (HIPAA), and/or Payment Card Industry Data Security Standard (PCI DSS). A specific data element may be tagged with all the following: (1) GDPR; (2) CCPA; and (3) C&IB meaning the data element is relevant to GDPR, CCPA regulations and is used specifically by the Commercial and Institutional Bank business.

Chief Information and Security Officer (CISO) classification tags (STC) may characterize a data element of the semantic layer 320 with an information security and data protection perspective. In one example, CISO classification tags for a data element may include general personally identifiable information (general PII or GPII), sensitive personally identifiable information (sensitive PII or SPII), business contact information (BCI), and protective health information (PHI), and/or primary account number (PAN) to identify data elements that contain sensitive information. A specific data element may be tagged with all the following: (1) SPII; and (2) PAN meaning that data retrieved through the data element must be handled accordingly to PAN and sensitive PII data protection policy. CISO data protection policy may require sensitive data elements be obfuscated in all data objects 308a-n across all environments (e.g., production, quality assurance, test, and development) configured in the data virtualization platform 120 to protect sensitive data being retrieved by data consumers 130a-130n in clear-text through the consumption data views 322a-n of the consumption layer 314.

Across the plurality of data sources 102a-102n, data objects 308a-n must comply to both data consistency and data obfuscation rules before being configured into the data mesh system 100. Data consistency is a prerequisite for obfuscation consistency and data consistency is foundational to achieving on-demand data integration through the data mesh system 100. If an obfuscation algorithm is applied to a data element of a data object that does not adhere to data consistency rules, the result will be inconsistency of obfuscated data across data objects which results in referential integrity issues and may prevent or inhibit on-demand integration, at a minimum adding significant compute, latency, and operational cost. In one example, a social security number is formatted in a first data object as an NNN-NN-NNNN (Alphanumeric text), and a second data object as NNNNNNNNN (Integer). Although the same obfuscation algorithm is applied, different values are returned by the algorithm resulting in referential integrity issues. Therefore, prior to the data obfuscation process, data objects must adhere to data consistency rules. To achieve data consistency, data contained in data objects 308a-n must adhere to 1) the technical definition of the enterprise data dictionary (EDD), and if applicable 2) data quality rules define in the data quality rules (EDQ), and 3) valid values defined in the reference data (ERD). Once data consistency is achieved for a data object, it can then be obfuscated. This ensures the same value is returned by the obfuscation algorithm; hence, preserving data referential integrity. CISO data protection policy identifies those sensitive data elements that require data protection. Data security rules defined in the CISO Tokenization/Obfuscation standards (STS) are applied to the data contained in sensitive data elements of data objects 308a-n before being configured in the data mesh system 100. The invention requires a consistent data obfuscation process be used by all environments by tokenizing or masking sensitive data identified in CISO data protection policy. Using a consistent approach across all environments ensures completeness of testing, lowers code migration risk and facilitates code migration between environments. For example, a sensitive data element such as social security number must be technically defined consistently (e.g., 9-digit numeric value), data quality and valid values must adhere to social security definition. Once data consistency is achieved, the data is then obfuscated by employing the same obfuscation algorithm on the data element in all data objects 308a-n that contain social security across a plurality of data sources. Once data and obfuscation consistency are achieved for a data object, the data object can be configured in the data mesh. Data and obfuscation consistency ensure referential integrity allowing data views configured in the semantic layer 320 of the data mesh system 100 to be integrated on-demand using social security number in Data Query Language (DQL) statements such as JOIN, MERGE, UNION.

The data mesh system may perform high-speed query over data objects 104a-104n that are configured in the data mesh system. The data mesh system leverages a plurality of performance optimizations techniques on data objects 308a-n to achieve high-speed query with significantly reduced response time performance. The plurality of performance optimization techniques include:

1) Data objects must be physical objects, base data views 304a-n of the base layer 310 must retrieve data from physical data objects 308a-n. For example, a data object in a relational database source must be a physical table and not a logical table view. Use of views as data objects is discouraged.

2) Use of functions or methods in Data Query Language (DQL) statements are discouraged in data views of the semantic layer 320. Statements must be rewritten eliminating the use of functions or method that may prevent the data source optimizer from using an established data object index. For example, the query ‘select * from Customer where YEAR(AccountCreatedOn)=2005 and MONTH(AccountCreatedOn)=6’ prevents the optimizer from using the ‘AccountCreatedOn’ index on the ‘Customer’ data object. The query must be rewritten to ‘Select * From Customer Where AccountCreatedOn between ‘6/1/2005’ and ‘6/30/2005’ to allow the optimizer to use the ‘AccountCreatedOn’ index to increase performance.

3) Statistics are enabled on data objects 104a-104n being connected to the data mesh system 100. This performance enhancement is typically available on database technologies used by many data sources 102a-102n. The data source SQL optimizer uses the statistics collected for data objects 308a-n. Statistics are information about indexes and their distribution with respect to each other. The SQL optimizer uses this information to decide the least expensive path to satisfy a query. Outdated or missing statistics information may cause the optimizer to take a less optimized path hence increasing the overall response time.

4) Foreign keys constraints ensure data integrity at the cost of performance. Data objects 308a-n should not have foreign keys defined. The invention uses a technical verification process to validate foreign keys on a periodic basis to ensure data referential integrity.

5) Optimized indexes are created for data objects 308a-n. A) Indexes that return a high number of records that afterwards need to be sequentially searched are of low value and should be eliminated. Such indexes seldom help in speeding up DQL type queries and reduce the response time for DML type queries. B) An index that contains more than one data element of a data object 308a-n is called a composite index. Such indexes should be created on a data object when DQL queries reference multiple data elements in the WHERE clause and all data elements combined will result in significantly less rows to be returned than any one data element alone. C) A clustered index determines the physical order of data in a data object meaning data is physically sorted and stored according to the data elements in the index. In one example, a cluster index may be used on a telephone directory data object, which arranges data by last name. A clustered index should be created on a data object for efficiency when specific data elements are often searched for range of values. D) Append an integer surrogate key to a data object as a synonym to a non-integer natural key. A natural key is a key that is derived from the data itself, such as a customer ID, a product code, or date. A surrogate key is generated artificially, such as a sequential number, or a hash. A surrogate key is does not have any contextual or business meaning, it is a synonym for a natural key, manufactured “artificially” and used only for the purposes of query performance. The most frequently used approach for surrogate key value generation, by the invention, is an increasing sequential integer or “counter” value (i.e., 1, 2, 3). A surrogate key is appended to the data object as an additive data element and has a one-to-one correspondence to the natural business key of a data element. The invention calls for all non-integer natural business keys of data objects 308a-n to have a corresponding surrogate key. Data views configured in the semantic layer 320 of the data mesh system 100 must use data object surrogate keys rather than natural keys in Data Query Language (DQL) statements to improve query and data integration performance. Surrogate keys tend to be a more compact data type, such as a four-byte integer, than their corresponding natural key. This allows the data sources 102a-n to perform query on a single key column faster than it could non-integer columns or complex natural keys. In one example, an integer surrogate key is appended to a data object for the natural key ‘retail store’. Data views configured in the semantic layer 320 of the data mesh system 100 contain both the natural and surrogate key. Data integration pipelines configured in the semantic layer use surrogate keys and not natural keys to perform Data Query Language (DQL) statements such as JOIN, UNION, MERGE. Data views 422a-n configured in the consumption layer 314 return the natural keys and do not expose surrogate keys to data consumers 130a-130n. Surrogate keys are only used internal by the data mesh to speed computation operations, they are not an output to data consumers. Rules for surrogate key generation are maintained in the business glossary (EBG) to drive consistency both within and across data sources connected to the data mesh 100. Data inconsistency will result if surrogate keys are not applied consistently across data sources. E) When a composite index is appropriate, append an integer surrogate key to the data object as a synonym for the composite key. Using an integer surrogate key for a composite key significantly reduces IO and will speed query response time.

6) Storage I/O is among the slowest computer resource. As the size of data objects 308a-n increase, performance decreases. Data partitioning allows for data to be distribute across multiple physical or logical storage units called partitions. By dividing the data, query performance is improved by reducing the amount of data that needs to be scanned or accessed, I/O operations are reduced. Data partitioning adds efficiency to querying by improving scalability, reducing contention, and optimizing performance. A partition strategy provides a mechanism for dividing data by data consumption usage pattern. For example, if a data object is partitioned by date, queries that only need to access data from a specific month or year can be executed much faster than if they had to access all the data in the data source. The data mesh system facilitates the matching of data usage patterns to data storage technology. Partitioning allows each partition to be deployed on a plurality of data store technologies, based on cost and performance features of storage technologies. Partitioning allows each partition to be deployed in different locality, based on locality of data consumers. Hence the data mesh system utilizes partitioning to achieve both performance and cost objectives.

The data mesh system uses three data strategies partitioning: horizontal partitioning (e.g., sharding), vertical partitioning, and functional partitioning. Selection of the partitioning strategy is driven by the data product use case and expected query patterns. A) Horizontal partitioning (e.g., sharding) is a strategy where each partition is a separate data store, but all partitions have the same data schema. Each partition is known as a shard and holds a specific subset of the data. In one example all debit card PIN transactions may be stored by customer segmentation and/or date. This technique adds scale and parallelism. B) Vertical partitioning is a strategy where each partition holds a subset of data elements of a data object. The data elements are divided according to their usage pattern. For example, a subset of frequently accessed data elements might be placed in one partition and the reminder of data elements less frequently accessed fields in another. This technique minimizes IO. C) Functional partitioning is a strategy where data is aggregated according to how it is used by each bounded context in the system. For example, a data object holding originations may store the business object components that constitute a mortgage application in different partitions, or an employee salary data object may be partitioned by organization sonority. This technique can improve security by separating sensitive and non-sensitive data into different partitions. It can also improve operational efficiency by partitioning data in alignment with business process work streams. Many database technologies allow for configuration of partitions. When a data source technology permits partitioning, it should be used improve performance. The alternative is to configure data integration steps in the integration layer 312 of the semantic layer 320. Using partitioning on data source technologies that support the capability is preferred as it further distributes data processing. Partitioning may be used to improve performance, improve security, provide operational flexibility, provide operational efficiency, and improve availability. I/O operations speed up significantly since data can be fetched in parallel. The invention uses partitioning as a powerful technique to enable scaling and efficient data management of large data sources and data objects. Once the data objects are assessed to successfully conform with the data consistency rules, data obfuscation rules, and performance rules, the data objects can be connected to the base layer 310 of the data virtualization platform 120.

The data mesh system 300 use of composable data architecture techniques to plan, organize and build the data views of the semantic layer 312 to construct data products. Data views at all levels of semantic layer are purposely built as building blocks intended for reuse. This approach allows for data views be integrated in a myriad of ways to fulfill the data requirements of multiple data products using existing data components (‘data views’). Using the composable data architecture technique ensures A) that base layer data views 304a-n do not send redundant queries to data objects 308a-n reducing IO loads on data sources 102a-n. B) The use of composable data architecture techniques speeds delivery of data products over time. As more reusable data views are created in the semantic layer 320, the effort for building new data products is reduced. C) The use of composable data architecture techniques improves consistency by minimizing overlapping functionality which may have differing implementation causing data quality concerns by returning dissimilar data result sets.

To support high-throughput and secured data transfer to data consumers the data mesh is configured not to support detokenization by a data protection policy. The data mesh always delivers tokenized sensitive data to consuming applications. Once data is retrieved from the data mesh into a consuming application, the application can make detokenization calls if permitted to do so by data security policy.

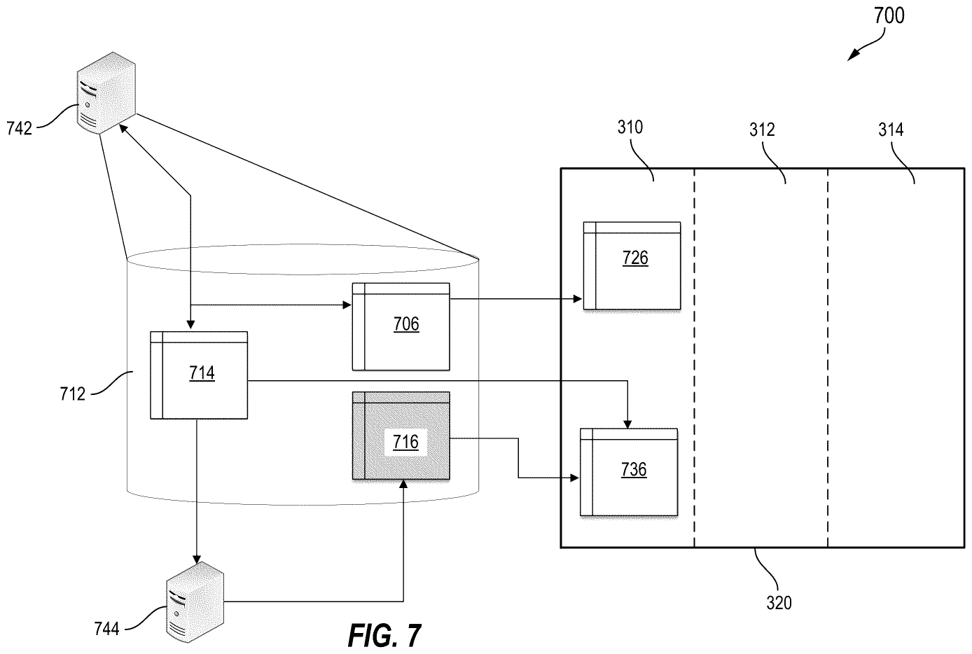

FIG. 7 shows a block diagram for a technical approach 700 to convert a non-conforming data object into a conforming data object, according to at least one embodiment of the present invention. The data mesh system requires data objects to conform with data consistency and tokenization consistency standards as a prerequisite to being on-boarded to the base layer 310 of the data virtualization platform 120. Data objects that conform to data consistency and tokenization consistency standards may be directly connected to the data mesh system through the base layer 310, without undergoing any data processing. A semi-manual validation process 306 is used to confirm adherence to data consistency and tokenization consistency standards to prevent data consistency, data quality, referential integrity, and obfuscation issues that may limit on-demand integration, slow performance, increase compute cost, and intra and inter data source referential integrity. When a data object is assessed and found to be non-conformant, it must be transformed to conform to the Business Glossary (EBG), Data dictionary (EDD), Data quality rules (EDQ), Reference data (ERD), CISO Tokenization/Obfuscation standards (STS), and technical development guidelines and best practices. Application development teams may need to make significant application and data object changes to reach compliance to the standards, especially legacy applications, 3^{rd} party data providers, and data sources that do not support the data protection technology being used for obfuscation. In practice, the work involved in transforming a data object to be compliant to enterprise standards is not trivial requiring significant application and data object changes. The technical approach 700 uses a temporal process to transform non-compliant data objects into compliant data objects and make the compliant data available for consumption through the data mesh system. The following technical temporal process is used to transform non-compliant data object to be compliant: A) data objects 706 and 714 are analyzed to validate compliance with business glossary (EBG), Data dictionary (EDD), Data quality rules (EDQ), Reference data (ERD), CISO Tokenization/Obfuscation standards (STS), and technical development guidelines and best practices. In the example, data object 706 meets all requirements and may be connected directly to the data mesh as a base data view 726, without any changes. In another example, data object 714 has violations that need to be resolved and may not be connected to the data mesh until it is made compliant. B) The following process steps are performed to make compliant data available to data consumers using a temporal data object 716 created in the business application 742 data source 712: 1) an application development team builds transformation code to resolve data consistency issues and ensure compliance to EBG, EDD, EDQ, and ERD. The last step in the code is to apply data protection obfuscation on sensitive data elements to comply with STS. The EBG, EDD, EDQ, ERD, and STS are referenced by the application development team to build the required transformation rules needed for compliance to standards; 2) the application development team builds a temporal data object 716 on the data source 712 to store compliant data once it is transformed. Data object 716 is configured to comply with technical development guidelines and best practices to achieve high performance; 3) the application development team deploys the transformation code to run on an external transformation server 744; 4) The application development team uses the transformation code to fix identified non-compliant data and/or data object definition, in data object 714, to comply with data consistency standards; subsequently obfuscated to comply with obfuscation standards; then store the compliant data in data object 716; 4) The technical verification process continues to run to ensure data object 714 and data object 716 remain mirrored data images differing in that data object 716 contains data that is in compliance to EBG, EDD, EDQ, ERD and STS standards; 5) To achieve near real-time data, the technical verification process can be schedule to run at very short intervals as a trickle feed; C) The temporal data object is assessed for compliance EBG, EDD, EDQ, ERD and STS to enterprise standards. Once data object 716 is validated to meet all standards, the data object 716 may be connected to the base layer 310 data view 736 in the semantic layer 320; D) the base layer data view 736 can then be used to query data object 716 by data views in the integration layer 712 and by data products configured in the consumption layer 714; E) When the application development team deploys the changes to resolve standard compliance issues in the business application 742 and data object 714, data object 714 may be reassessed; F) Upon validation of compliance to standards, data object 714 may be connected to the data mess system as a base layer 310 data view by repointing base data view 736 to data object 714; G) The technical verification process decommissioned by 1) Turning off the process; 2) archiving the technical verification process code and data stored in data object 716; 3) decommissioning the server 744 and purging the data object 716.

Data mesh requires data objects being connected to adhere to data consistency and tokenization consistency standards as a prerequisite to being on-boarded to the data mesh system. The manual process is augmented with a technical validation application to accelerate the process of validating data mesh compliance. As a precondition, the application requires access to the data objects planned to be connected to the data mesh and the system tables of the data source. The application uses metadata from the business glossary (EBG), Data dictionary (EDD), Data quality rules (EDQ), CISO Tokenization/Obfuscation standards (STS), and Reference data (ERD) to validate data object definition and content in supported data sources. As a precondition, an analyst must perform a mapping each data element of the data object being connected to the business glossary (EBG) term. Once the preconditions are satisfied, the application performs the following validations 1) analyzes systems table of the data source to validate the data object definition adheres to EDD definition, 2) analyzes each data element of the data object to ensure they adhere to EDD descriptor definitions such as minimums, maximums, ranges, type, formats, etc. 3) analyzes each data element of the data object to ensure content adheres to ERD definition, 4) Performs data quality validations on each data element to ensure adherence to EDQ data quality rules, 5) Validates data elements containing sensitive data adhere to STS obfuscation standards. 6) Validates performance configuration of the data object including A) data object is not a view, B) No use of functions, C) Statistics is turned on, if available, D) no foreign keys. 7) Validates referential integrity with foreign tables. Validations that cannot be automated require manual confirmation to be performed, many of these validations have a subjective component such as proper use of indexes, surrogate keys, and data partitioning to achieve high performance query.

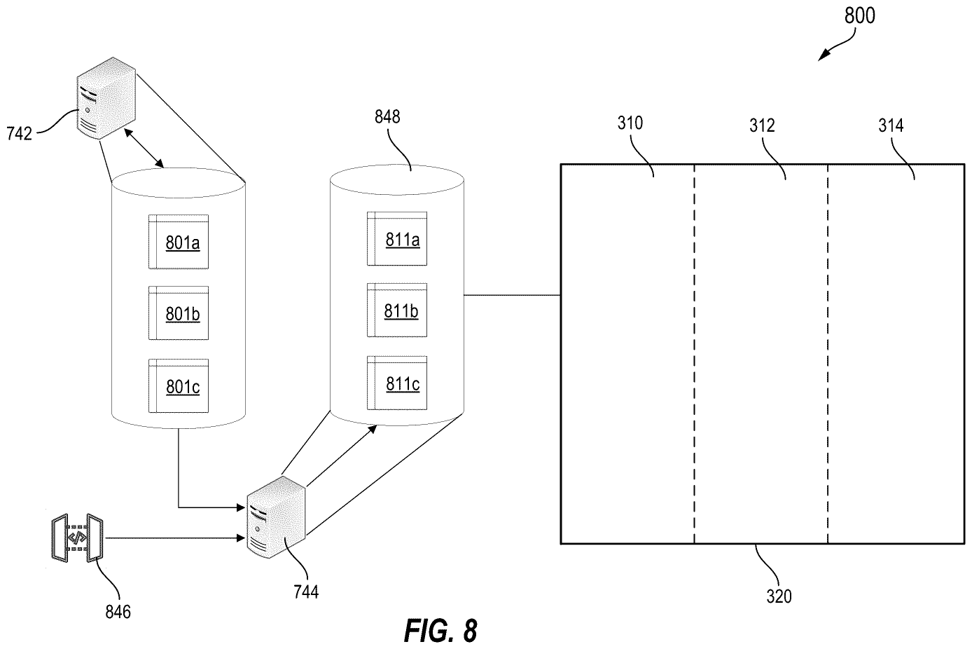

FIG. 8 shows a block diagram of the technical approach for connecting a data source to the data virtualization management server of the data mesh that does not meet data mesh requirements, data product or operational requirements according to at least one embodiment of the present invention. The data mesh system may require data objects, that are being connected, to adhere to data consistency and tokenization consistency standards as a prerequisite to being on-boarded to the data mesh system. An intermediate data platform 744 may be required when a data source does not meet data mesh, data product and/or operational requirements. The reasons for an intermediate platform may further include 1) data mesh query impact on the data source, 2) The data source does not support obfuscation, 3) The data source does not align to data product history requirements, 4) The data source is an business application interface, such as a API, which cannot be changed or may not meet speed requirements, 5) The data source is owned by a 3^{rd} party and cannot be changed. FIG. 4 shows a block diagram of the technical approach for connecting a data source that does not meet data mesh requirements to the data mesh. An intermediate data platform 744 is deployed to addresses data and platform gaps with the business application 742 environment and/or the business application interface (API) 846. The intermediate data platform 744 is used to 1) extract data from the business application 742 environment and/or the business application interface 846, 2) transform the data to make data compliant, 3) load the data into a persistence 848 storage environment that supports data mesh requirements. The data objects 811a-n maintained in the persistent storage platform can be configured into base views of the base layer 310 of the semantic layer 320.

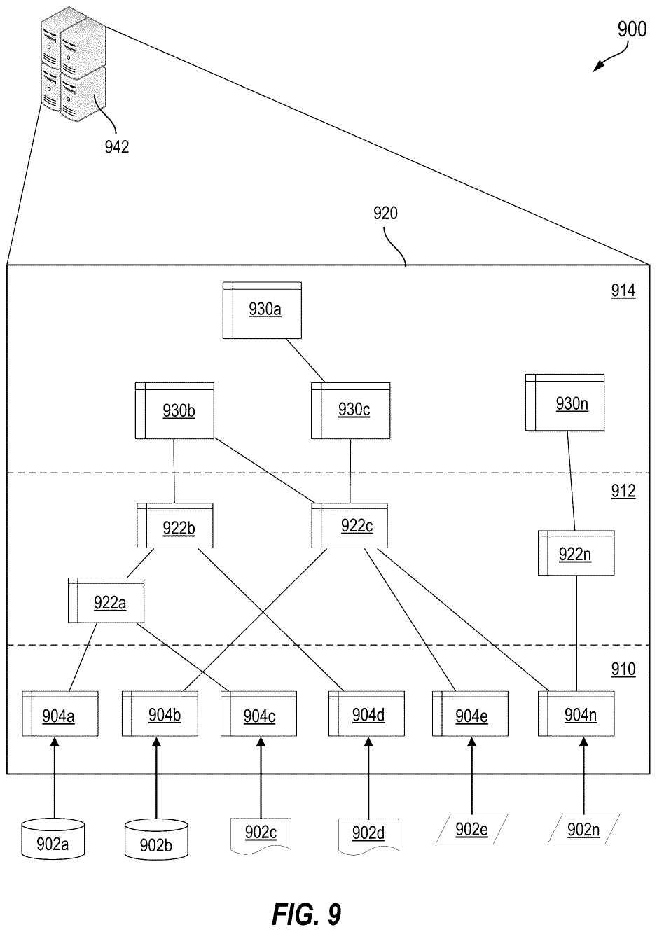

FIG. 9 shows a block diagram for on-demand integration using the data mesh system 900, comprising a plurality of data objects 902a-902n from a plurality of data sources, to a data virtualization platform 920, according to at least one embodiment of the present invention. The data virtualization platform 920 is configured to perform data integration processing using a connected graph of data views to build a plurality of domain-specific data products. Each domain is responsible for adherence to centralized governance ensuring cross-domain data consistency, tokenization consistency, and referential integrity. Data consistency, tokenization consistency, and referential integrity ensure cross-domain compatibility of semantic views defined in the semantic layer 920 allowing for reuse. The integration layer 912 comprises a plurality of integration views 922a-n where each integration view 922a-n comprises specific data-processing steps to transform and integrate data retrieved from lower-level views that it queries. In one example, the data processing steps in a first integration view 922a reads data from a first base view 904a and a third base view 904c from the based layer 910 to integration layer 912, the integration view 922a is comprised of processing instructions that may include integration, filtering, and aggregation operations on data that is retrieved. This constitutes a data processing step, one of many processing steps in an end-to-end data processing plan forming a data pipeline to manufacture a data product, the consumption view 930a in the consumption layer 514. The base views 904a-n, integration views 922a-n, and consumption views 930a-n that comprise the semantic layer 920 are available to all domains to reuse, barring access authorization. Domains are required to document the views that they develop and own in the semantic layer 920 to aid in reuse. The documentation is captured in the internal data catalog of the data virtualization management server 942. The practice of sharing views across domains results in increasing the speed of delivery of data products, minimizes duplication, drives data consistency, reduces code base, and associated infrastructure cost. It also permits a domain to share its data with other domains. Accordingly, a consumption view 930a represents a single representation of data, a data product, constructed using data from a plurality of disparate sources without having to copy or move the data, built using a sequence or views created by one or more domains.

The data virtualization platform 920 works with a plurality of domains as part of the data integration process. The domains are specific to a line of business or department. Domains are responsible for verifying data and tokenization consistency of data sources they use to build a data product. Domains are responsible for adhering to all data management and data architecture governance. Domains are responsible for managing and documenting all views that they create to generate data products that may be used by business intelligence applications in the consumption layer 914. Each domain is responsible for owning the data pipelines they build. Domains are responsible for access control over the semantic views that they create. Domains must document which data sources are used to retrieve data for each data product they build. Data consumers must request access permission for the consumption views 930a-n, data products, they wish to query as well as data access to all the underlying data sources and data objects providing raw data.

The data virtualization management server 942 is responsible for executing query plans built using connected views in the semantic layer 920. Data consumers only have access to views 930a-n of the consumption layer 914 ‘data products’. Federated development teams have access to all view of the semantic layer 920 for building new data products. The data mesh system 900 utilizes federated ownership of views that comprise the semantic layer 920. Each view of the semantic layer 920 is owned by a specific domain, federating data and data view ownership among domain owners. The domain owners are held accountable for data views which they create and the data returned when the data views are queried, while the data views adhere to data management and data architecture governance and policies defined for universal interoperability and data quality. These are cross-functional development teams that understand the data source(s) and process used to create the data product. This federated approach speeds delivery of data requirements for business purposes.

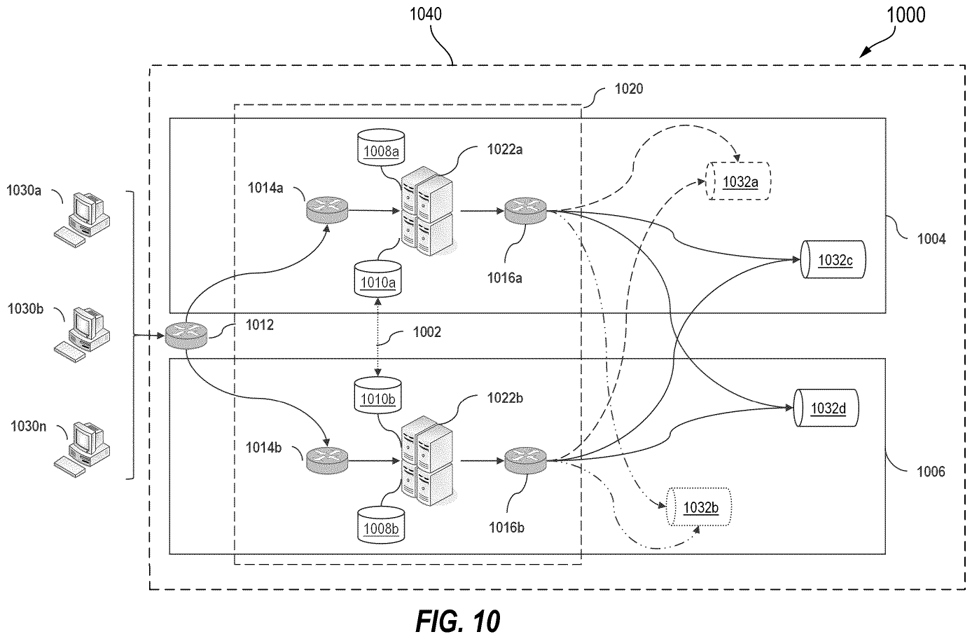

FIG. 10 shows a logical diagram for an on-premises data virtualization deployment 1000 for a plurality of clients 1030a-n querying data through a data virtualization platform 1020, according to at least one embodiment of the present invention. The data virtualization platform 1020 is deployed as an active-active application that spans all on-premises data centers 1040 (the first on-premises data center 1004 and the second on-premises data center 1006). The data virtualization platform 1020 comprises a plurality of data virtualization management servers 1022a-b, a first local load balancers 1014a-b, a second local load balancers 1016a-b, a plurality of local cache databases 1008a-b, and a plurality of metadata databases 1010a-b. The plurality of clients 1030a-n query data from a plurality of data sources 1032a-d through a plurality of data products using the data virtualization platform 1020. A plurality of APIs and web service may be configured as a front-end interface to the data virtualization platform 1020 to receive queries from the clients 1030a-n. The queries are passed to the Global Traffic Manager (GTM) 1012 that acts as an DNS server, handling DNS resolutions. The GTM determines where to resolve query traffic requests among multiple data center infrastructures 1040. The GTM 1012 may be configured to load balance query requests selecting an on-premises data center (e.g., first datacenter 1004 or second data center 1006) based on the physical proximity of the resource to the client making the request or request latency. Queries passed to the first local load balancers 1014a-b from the GTM 1012 route traffic to a specific data virtualization management server to handle creation and execution of a query plan to retrieve data from a plurality of data sources 1032a-d to service the query request. Each data virtualization management server has access to a cache database 1008a or 1008b configured in the data virtualization management server cluster 1022a or 1022b within a data center 1004 or 1006. The cache databases 1008a-b may speed the servicing of secondary query requests requiring data that has been previously cached. Each data virtualization management server has access to the metadata database 1010a or 1010b configured in the data virtualization management server cluster 1022a or 1022b within a data center 1004 or 1006. The metadata databases 1008a-b may be used by the data virtualization management server to build query plans using data product and data source metadata. The metadata databases may be uses by the plurality of data virtualization management servers 1022a-b to persistently store operational and technical metadata. Resiliency of the data virtualization platform is accomplished by implementing warm backup of metadata database 1010a-b, and configuration of data virtualization management servers 1022a-b, a first local load balancers 1014a-b, and a second local load balancers 1016a-b. Metadata is replicated bi-directionally between the data virtualization management servers 1022a-b of each data center (the first on-premises data center 1004 and the second on-premises data center 1006) every 5 seconds.

The dotted line 1002 indicates bi-directional metadata replication between the data virtualization management server clusters 1022a-b in a first datacenter 1004 and a second datacenter 1006. The bi-directional metadata replication between data centers is performed by the data virtualization management servers. Enforcing tight consistency across metadata databases 1010a-b across all data centers is required to enable load balancing and resiliency. The GTM 1012 may be configured to route query traffic to on-premises datacenters 1040 (the first on-premises data center 1004 and the second on-premises data center 1006) where global network traffic is routed based on latency and system resource on the first datacenter 1004 and the second datacenter 1006, in addition to physical proximity of the resource to the client.

In one example, the GTM 1012 determines that the second datacenter 1006 is not operational and begins to route all traffic to other on-premises data centers 1040 that are operational to service query requests (the first datacenter 1004), traffic is routed based on proximity, latency, and system resource to optimize query routing. Once the outage at the second datacenter 1006 is resolved, the status of the second datacenter 1006 transitions to operational. The global load balancer/GTM 1012 detects that the second datacenter 1006 is operational and begins to distribute traffic to both the first datacenter 1004 and the second datacenter 1006. First local load balancers 1014a-b may be configured to begin to distribute query traffic to the warm backup servers when it detects a set of primary and backup servers going out of service. In one example, a first local load balancer 1014a detects an outage of a set of data virtualization management servers and backups 1022b. To keep server capacity at maximum licensed level, the local load balancer 1014a may be configured to begin to distribute traffic to the warm backup servers within the plurality of data virtualization management servers 1022a in the first datacenter 1004. When the first local load balancer 1014a detects data virtualization management servers and backups 1022b in the second datacenter 1006 are operational and servicing query requests, the local load balancer 1014a stops routing query traffic to warm backup servers in the first datacenter 1004. The operational warm backup servers go back to an idle state once they complete their current workloads. This approach maintains maximum license usage and capacity.

In another example, a first local load balancer 1014a detects a failure of one of the operational data virtualization management servers 1022a in the first datacenter 1004. The first local load balancer 1014a begins to distribute traffic to a warm backup server within the plurality of data virtualization management servers 1022a in the first datacenter 1004. The warm backup server begins receiving and processing query requests. Once the issue is resolved, the status of the offline server transitions to operational. The first local load balancer 1014a detects that the off-line server is operational and begins distributing new query traffic to the operational server and stops distributing new query traffic to the warm backup server. The warm backup server goes back to idle once it completes its current workloads. This approach maintains maximum license usage and capacity.

In various on-premises datacenter embodiments 1040, the first local load balancers 1014a-b are positioned between the GTM 1012 and the plurality of data virtualization management servers 1022a-b in datacenters 1004 and 1006, and a second local load balancers 1016a-b are positioned between the plurality of data virtualization management servers 1022a-b and the plurality of data sources 1032a-d in datacenters 1004 and 1006. The second local load balancers 1016a-b are required to manage routing sub-query requests to the plurality of data sources 1032a-d having is a plurality of business applications deployment approaches: active-active and warm-hot. Each approach updates data sources 1032a-d differently and the complexity of data currency is managed using the second local load balancers 1016a-b. In active-active business application deployments, all data persistence is current, data sources 1032c-d have tight consistency enforced by the business application. Sub-query requests can be routed to any of the data sources of an active-active business application (solid lines from local load balancer 1016a-b to data sources 1032c-d). The second local load balancers 1016a-b maintain metadata sub-query response time from data source 1032a-d. In active-active business application deployments where data is current in multiple datacenters 1004 and 1006, the second local load balancers 1014a-b can be configured to route sub-query requests to the least constrained data source 1032c-d based on the response time metadata collected by the second local load balancers 1014a-b, to manage query processing loads on active-active data sources 1032c-d. This practice reduces sub-query response latency and query bottlenecks. In warm-hot business application deployments, data is persisted in multiple datacenters 1004 and 1006. One database 1032a is the current business application database in datacenter 1004, and one backup database 1032b eventually becomes current using a data replication method embodied as part of the business application's resiliency plan. Sub-query requests are routed only to the current data persisted in data source 1032a (dash lines from local load balancer 1016a-b to data source 1032a). In the case of fail-over, database 1032b becomes the current business application database and sub-query requests from the data virtualization management servers 1022a-b are routed to the backup data source 1032b for handling (dash-dot-dot lines from local load balancer 1016a-b to data source 1032b). Sub-query requests are routed to the backup data source 1032b in datacenter 1006 until the data source 1032a becomes operational in datacenter 1004. This approach also resolves complications that arise when business applications purposely switch between on-premises datacenters on a periodic basis to adhere to business resiliency practices.

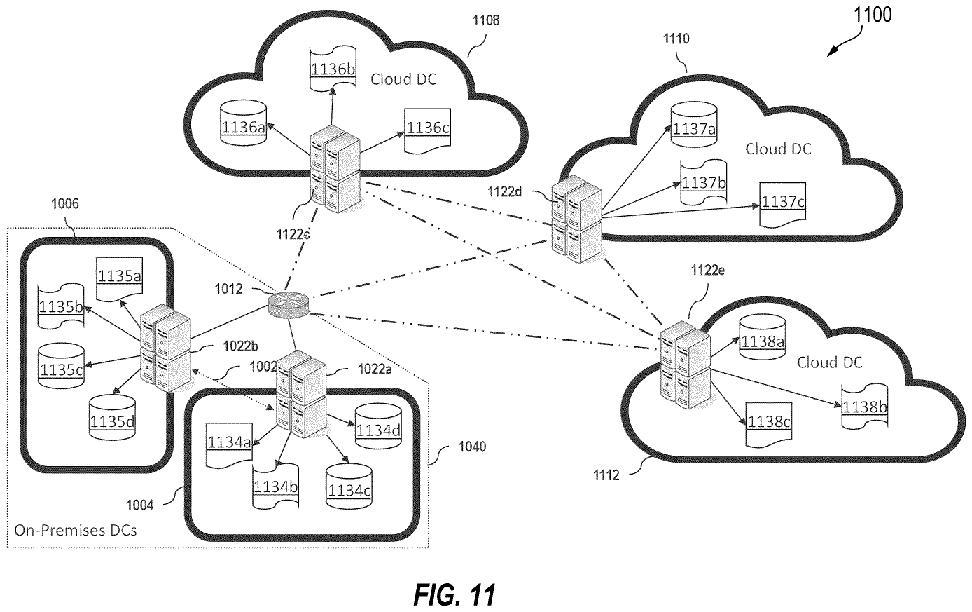

FIG. 11 shows a logical diagram for a hybrid-cloud deployment of data mesh system 1100 connecting data from a plurality on-premises and cloud data centers inclusive of a first on-premises data center 1104, a second on-premises data center 1106, a first cloud data center 1108, a second cloud data center 1110, and a third cloud data center 1112, according to at least one embodiment of the present invention. In various embodiments, the multi-cloud and hybrid-cloud datacenters may include combinations of on-premises, public cloud, and private cloud data centers, data mesh is a key component of a modern data architecture providing elasticity, availability, and cost savings. All the datacenters have an instance of data virtualizations management server 1022a-b, 1122c-e. The data virtualization management servers 1022a-b, 1122c-e are interconnected in a network to provide full visibility into the data, regardless of where it resides, enabling integration of data between a mix of private clouds, public clouds, and on-premises data centers. This deployment architecture is more sophisticated that the on-premises-only deployment architecture depicted in FIG. 10 enabling enhanced operational efficiencies. The hybrid-cloud deployment of data mesh system 1100 enables data virtualization management server instances 1022a-b, 1122c-e to publish data products and data services to data consumers across all data centers using one integrated data catalog. Data consumers may query through the connected network of data virtualization management servers 1022a-b, 1122c-e according to at least one embodiment of the present invention. The hybrid-cloud deployment strategy is particularly effective when the enterprise is dealing with particular challenges: a) Users are not located near any data center, or are widely spread out geographically, b) Addressing compliance regulations tied to specific countries for storing data, c) With complex data center topologies that maintain environments in which private and public clouds are used with on-premises resources, d) When applications are not resilient, which can affect disaster recovery with the loss of a single data center, e) Traceability of complex data lineage, f) minimizing data replication, g) reducing data attach surface. The hybrid-cloud deployment of data mesh system 1100 is an innovative approach using data virtualization technology for holistic hybrid-cloud data management, to overcome the defined challenges in a cost-efficient manner. Public and private cloud deployments 1122c-e differ from on-premises deployments 1022a-b in that there is no direct cross-location connectivity to remote data sources in other on-premises and cloud data centers. On-premises data virtualization management server instances 1022a-b are connected to all on-premises data sources, a query request for a data source within on-premises data centers 1040 may be routed to any on-premises data virtualization management server instance 1022a-b that is available to handle the request. A load balancer 1012 sits in front of all on-premises data virtualization management server instances 1022a-b and routes query requests based on configured load balancing rules. Cloud data virtualization management server instances 1122c-e are configured to have direct access to data sources with the same data center, they are not configured to have direct access to data sources in other data centers. Data virtualization management server instances, running in different cloud and on-premises data centers, may connect to each other and facilitate moving query processing to the data virtualization management server instances and data source systems where the data is located. In one example, a data consumer connected to the data virtualization management server 1022a in data center 1004 submits a query request for data from data source 1134d, query processing is handled by the data source 1134d and the local data virtualization management server 1022a. In a second example, a data consumer connected to the data virtualization management server 1022a in data center 1004 submits a query request for data from data source 1135d, query processing is handled by the data source 1135d and the local data virtualization management server 1022a. Both of the on-premises data virtualization management server instances 1122a-b are configured for direct access to data source 1135d. In a third example, a data consumer connected to the data virtualization management server 1022a in data center 1004 submits a query request for data from data source 1137a in the second cloud data center 1110, the query request is routed to data virtualization management server 1122d. Query processing is handled by the data source 1137a and data virtualization management server 1122d in the second cloud data center 1110. Only the result set is returned to data virtualization management server 1022a and delivered to the data consumer. In another example, a data consumer connected to the data virtualization management server 1122d in cloud data center 1010 submits a query request for data from data source 1134d in on-premises data center 1004, the query request is routed to the GTM load balancer 1012 for on-premises data centers 1040. The load balancer detects that data virtualization management server 1122a is busy, based on load balancing rules, so the load balancer forwards the query request to data virtualization management server 1022b in on-premises data center 1006 for handling. Query processing is handled by the data source 1134d in on-premises datacenter 1004 and data virtualization management server 1022b in on-premises data center 1006. Only the result set is returned to data virtualization management server 1122d in the second cloud data center 1110 and delivered to the data consumer. Cloud deployments of data virtualization management servers 1122c-e may be used to achieve specific security and control objectives requiring data be localized based on different countries, jurisdictions, etc. Cloud deployments of data virtualization management servers 1122c-e may be configured for auto scaling to provide scalability and resilience. Each cloud instance 1122c-e may be configured to scale depending on the type of workload being handled. Cloud deployments of data virtualization management servers 1122c-e may be connected only to local cloud data sources. Connecting the data virtualization management server instances 1122a-e to each other enables all data to be accessed by data consumers, whether this data is from on-premises data sources or data sources in any of the connected cloud environments. This hybrid-cloud deployment architecture permits data products to be created using data sources from all connected data centers. In one example, a user connected to the cloud data virtualization management server instance 1122c in cloud data center 1008 submits a query that joins data from 1138a located in the third cloud data center 1112 and data from data source 1137a located in cloud data center 1010. Data virtualization management server 1122c creates a query plan and delegates sub-queries to data virtualization servers 1122d and 1122e for handling. Query processing is handled by the data source 1137a and data virtualization management server 1122d in the second cloud data center 1110; additionally, query processing is handled by the data source 1138a and data virtualization management server 1122e in the third cloud data center 1112. Only the query results that satisfy the sub-query request are passed back to the cloud data virtualization server instance 1122c for final processing before being delivered to the user. Further operational efficiency may be achieved with the hybrid-cloud deployment of data mesh system 1100 minimizing cloud egress costs while enhancing performance. The data virtualization management servers 1122c-e work with localized data in each cloud data center 1108, 1110 and 1112 and thus avoids having to replicate data and move it around, unless the need is driven by a requesting query/application. The optimizer component of data virtualization technology used by the data virtualization management servers 1022a-b, 1122c-e is configured to delegate the queries to the data sources doing so in an efficient and cost-effective way, to minimize data movement when integrating data across hybrid-cloud environments. The optimizer of the data virtualization technology may leverage data source statistics as it constructs a query plan. The data virtualization technology used by the data virtualization management servers 1022a-b, 1122c-e may be configured to use local caching of query results to minimize egress of hot data having a positive impact on cost management.

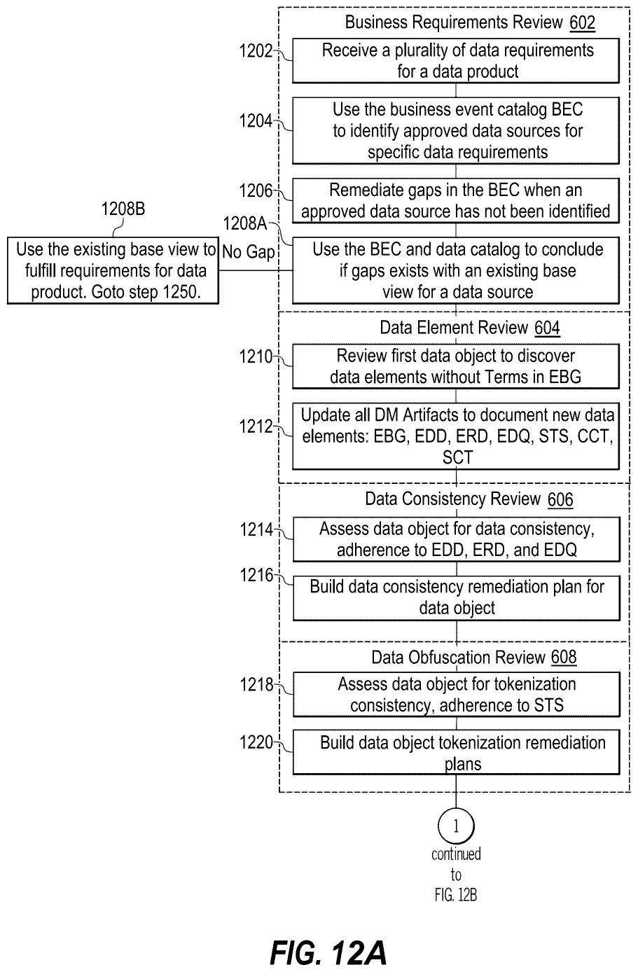

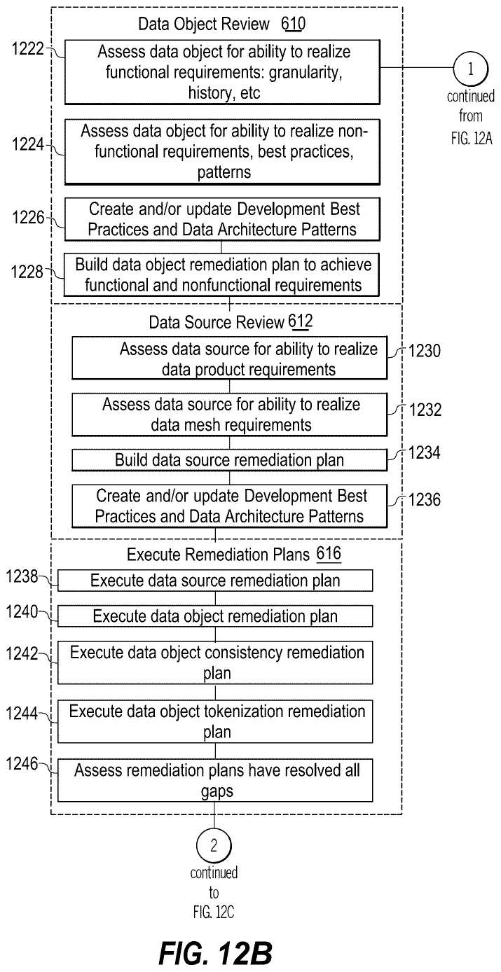

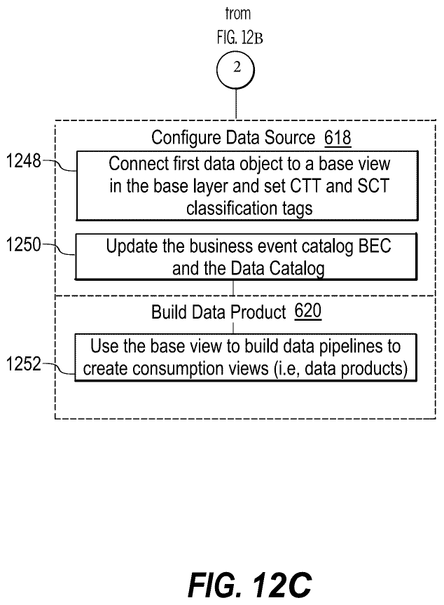

FIGS. 12A-C show a logic flow diagram 1200 for on-boarding data products that require data from a plurality of data sources through an on-demand integration process provided by a data virtualization platform, according to at least one embodiment of the present invention. The purpose of the on-boarding process is to drive data standardization, mature data management governance, mature architecture governance, and promote reuse. The data mesh system receives, at step 1202 of the on-boarding process, a plurality of requests for new data products and enhancements to existing data products, each request, each having functional and non-functional requirements. The plurality of requests are first validated for completeness including data requirements. Step 1204, the CDO uses the business event catalog BEC to identify approved data sources for specific data requirements for a data product ensuring there are controls over where data is sourced, Only CDO sanctioned data sources may be connected to the data mesh. Step 1206, the CDO must remediate gaps in the BEC when an approved data source has not been identified to fulfill the requested data requirements. The CDO must work across business teams and identify the best source for the specific data being requested. Step 1208A, for data requirements where a sanctioned data source is identified in the BEC, the CDO must identify if existing base views require modifications or enhancements to fulfill the data product requirements. Step 1208B, if no data gaps are found upon review of data requirements to fulfill a data product request, meaning all data is available in existing base views, no further data analysis is required (and skip to step 1250). Steps 1210-1212 ensure key data management artifacts are updated accordingly for new or changing data elements. Step 1210, make required updated to the business glossary (EBG). If a data gap is determined, each new or changing data element will need a new or refined Term definition in the EBG. Step 1212, update all data management artifacts: 1) EBG, with new or changing Term definitions, 2) EDD, with new or updated data definitions for data elements, 3) ERD, with new or updated reference data, 4) EDQ, with new or updated data quality rules, 5) BEC, to capture potential new or changing sanctioned business events from a plurality of data sources and the associated base views, 6) STS, with new obfuscation rules for sensitive data elements, 7) CCT and SCT, with new or changing CISO and CDO classification tags. Step 1212 ensure all data management documents updated on a constant bases, keeping them living documents. Steps 1214-1236 are used to assess the data object and the data source. Steps 1214 and 1216 use the EDD, ERD, and EDQ to evaluate data elements for data consistency and accordingly build a “data consistency” remediation plan for data objects being updated or added. Steps 1218 and 1220, use the STS to evaluate data elements for obfuscation consistency and accordingly build a “data obfuscation consistency” remediation plan for data objects being updated or added. Steps 1222-1228, assess new or changing data source objects (e.g. tables, topics, files) to ensure data product functional and non-functional requirements can be realized, such as data latency, history, granularity, performance. Data objects are evaluated for conformance to best practices to address high-performance such as index, data partitioning, use of surrogate keys, etc. A data object remediation plan is developed to ensure both functional and non-functional requirements can be achieved. One outcome of this review may be addressing a non-conforming data object. Another outcome of this review may be identifying that an intermediate data technology may be needed to address data persistence, performance, history, etc. Development best practices and data architecture patterns are updated with changes or additions to rectifying missing or changing development and data architecture standards, patterns, technical development guidelines and best practices. Steps 1230-1236 are used to assess the data source system for its ability to achieve data product and data mesh requirements, such as RPO, RTO, response time, data persistence, and ability to tokenize. A data source remediation plan is built to address identified gaps. Development best practices and data architecture patterns are updated with changes or additions to rectifying missing or changing development and data architecture standards, patterns, technical development guidelines and best practices. Steps 1214-1236 create several potential remediation plans. These plans are used to estimate the work effort, skills, impacted teams, risk, timing, etc. The cost and timing need to be weighed against the data product benefits and a go/no-go decision needs to be made, not all proposed data products are deployed, only those that make financial sense or have significant business value. Another outcome of the analysis may be that the wrong data object or data source was selected. In this case, the CDO must select a new object or data source to fulfill the data product requirements and the process repeats. Steps 1240-1246, execute the remediation plans following a “go” decision. There are dependencies between the remediation plans that must be considered as an execution plan is formed. Step 1238 executes data source remediation plan. Step 1240 executes data object remediation plan. Step 1242 executes data object consistency remediation plan. Step 1244 executes data object tokenization remediation plan. Step 1246 assesses the outcome of the plurality of remediation plans to determine whether all gaps have been resolved. If gaps are found during the assessment, the remediations plans need to be revised and approval to execute the revised plans need to be obtained. In some cases, gap can be accepted by the data product team if the gaps do not violate data mesh requirements such as data consistence and tokenization consistency. Steps 1248-1252 Connect the plurality of new or changing data objects to a base views in the base layer including base view schema definition, data catalog update and assignment of CTT and SCT classification tags. The business event catalog is updated to reflect new sanctions business events once the base views and data catalog are updated. The base views can be used by the data product development team to build data products The data mesh system is used to create an integration pipeline from a plurality of base views to a consumption view. The process ensures that data management, data architecture and development artifacts are maintained and improved over time. It ensures a standard approach to connecting data to the data mesh. It accounts for shortfalls in that may exists in a complex technical environment. It promotes reuse and speed in delivery of data requirements to the business.

In one general aspect, therefore, the present invention is directed to data-mesh systems and methods. A method according to various embodiments includes a first step of identifying, by a server, a plurality of data objects to be integrated on-demand into a data virtualization platform, wherein the plurality of data objects stored at a plurality of data sources. The method further includes the step of determining, by the server, a data conformity status of a first data object of the plurality of data objects, wherein the data conformity status is based on a data consistency rule applied by a data catalog stored electronically by the server, wherein the data catalog comprises an enterprise data dictionary (EDD) and an enterprise business glossary (EBG), and a plurality of classification tags for data elements within the plurality of data objects. The method further includes the step of obfuscating, by the server, with a tokenization algorithm, a subset of the data elements of the first data object based on a data security rule, in response to determining by the server that the data conformity status of the first data object is a conforming data object, and wherein the subset of the data elements of the first data object are tokenized data elements to comply with the data security rule. The method further includes the step of connecting, by the server, the first data object to a base layer of the data virtualization platform, in response to determining that the first data object complies with the data security rule, wherein the base layer comprises a mapping to a plurality of conforming data objects. The method further comprises the step of tagging, by the server, the data elements of the first data object based on the plurality of classification tags. And the method further includes the step of mapping, by an integration layer of the data virtualization platform, the first data object in the base layer to a consumption layer of the data virtualization platform, and wherein the consumption layer is the only layer of the data virtualization platform accessible to a client device.

In various implementations, the method further includes the steps of determining, by the server, the data conformity status of the first data object is a non-conforming data object based on the data consistency rule and the data catalog; and performing, by the server, a transformation of the first data object from the non-conforming data object to the conforming data object at a first data source associated with the first data object.

In various implementations, the transformation of the first data object to the conforming data object is performed as a temporal trickle process at the first data source, and wherein the first data source comprises a temporal data structure.

In various implementations, the data consistency rule is based on the EDD and the EBG determined by a line of business domain associated with the first data object.

In various implementations, the plurality of data objects are not extracted from the plurality of data sources.

In various implementations, the method further includes the steps of determining, by the server, the tokenized data elements are non-integer business keys data elements; generating, by the server, integer surrogate keys for the non-integer business keys data elements; and replacing, by the server, the non-integer business keys data elements with the integer surrogate keys.

In various implementations, the consumption layer includes only a tokenized consumption view, wherein the consumption layer does not detokenize of the plurality of data objects according to a data protection policy.

In various implementations, the plurality of data objects are mapped to a base view in the base layer in a one-to-one relationship, wherein one-to-one relationship eliminates inconsistencies in data retrieval from the plurality of data sources.

In various implementations, the plurality of classification tags implement a data security schema associated with data privacy standards, and wherein the data privacy standards comprise California Consumer Privacy Act (CCPA), Gramm-Leach-Bliley Act (GLBA), general data protection regulation (GDPR), Payment Card Industry Data Security Standard (PCI DSS), and Health Insurance Portability and Accountability Act (HIPAA).

In various implementations, the plurality of data objects are tokenized in the base layer, the integration layer, and the consumption layer of the data virtualization platform.

In various implementations, the integration layer includes a plurality of federated pipelines connecting the base layer and the consumption layer, and wherein the plurality of federated pipelines are associated with domain-specific data products.

In another general aspect, the present invention is directed to a data virtualization system that includes a global load balancer that receive a plurality of query requests from a plurality of client devices; and direct a query request of the plurality of query requests to a first load balancer in a first production environment or a second load balancer in a second production environment. The system further includes a first deployment server communicably coupled to the first load balancer in the first production environment, wherein the first load balancer is positioned between the first deployment server and the global load balancer, a second deployment server communicably coupled to the second load balancer in the second production environment, wherein the second load balancer is positioned between the first deployment server and the global load balancer, a third load balancer communicably coupled to the first deployment server, wherein the third load balancer is positioned between the first deployment server and a plurality of data sources, and a fourth load balancer communicably coupled to the first deployment server, wherein the third load balancer is positioned between the second deployment server and the plurality of data sources. In various implementations, the third load balancer receives a first query request of the plurality of query requests, determines a first latency response time between the third load balancer and the plurality of data sources in the first production environment, determines a second latency response time between the fourth load balancer and the plurality of data sources in the second production environment, and route the first query request through the second production environment when the second latency response time is less than the first latency response time, and routes the first query request through the first production environment when the first latency response time is less than the second latency response time.

In various implementations, the fourth load balancer further receives a second query request of the plurality of query requests, determines a third latency response time between the fourth load balancer and the plurality of data sources in the second production environment, determine a fourth latency response time between the third load balancer and the plurality of data sources in the first production environment, and routes the second query request through the first production environment when the fourth latency response time is less than the third latency response time, and routes the second query request through the second production environment when the third latency response time is less than the fourth latency response time.

In various implementations, the first deployment server includes a first active server and a first warm backup server, and wherein the first load balancer is configured to route a third query request of the plurality of query requests to the first warm backup server of the first deployment server based on a server outage in the second production environment.

In various implementations, the second deployment server includes a second active server and a second warm backup server, and wherein the first load balancer routes a fourth query request of the plurality of query requests to a warm backup server of the first deployment server based on the server outage in the second production environment.

In various implementations, the first load balancer determines that the first active server of the first deployment server is offline in the first production environment, and routes a fifth query request of the plurality of query requests to the first warm backup server of the first deployment server or the second deployment server.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A method for on-demand data integration, the method comprising:
identifying, by a server, a plurality of data objects to be integrated on-demand into a data virtualization platform, wherein the plurality of data objects stored at a plurality of data sources;
determining, by the server, a data conformity status of a first data object of the plurality of data objects, wherein the data conformity status is based on a data consistency rule applied by a data catalog stored electronically by the server, wherein the data catalog comprises an enterprise data dictionary (EDD) and an enterprise business glossary (EBG), and a plurality of classification tags for data elements within the plurality of data objects;
obfuscating, by the server, with a tokenization algorithm, a subset of the data elements of the first data object based on a data security rule, in response to determining by the server that the data conformity status of the first data object is a conforming data object, and wherein the subset of the data elements of the first data object are tokenized data elements to comply with the data security rule;
connecting, by the server, the first data object to a base layer of the data virtualization platform, in response to determining that the first data object complies with the data security rule, wherein the base layer comprises a mapping to a plurality of conforming data objects;
tagging, by the server, the data elements of the first data object based on the plurality of classification tags; and
mapping, by an integration layer of the data virtualization platform, the first data object in the base layer to a consumption layer of the data virtualization platform, and wherein the consumption layer is the only layer of the data virtualization platform accessible to a client device.

2. The method of claim 1, further comprising:
determining, by the server, the data conformity status of the first data object is a non-conforming data object based on the data consistency rule and the data catalog; and
performing, by the server, a transformation of the first data object from the non-conforming data object to the conforming data object at a first data source associated with the first data object.

3. The method of claim 2, wherein the transformation of the first data object to the conforming data object is performed as a temporal trickle process at the first data source, and wherein the first data source comprises a temporal data structure.

4. The method of claim 1, wherein the data consistency rule is based on the EDD and the EBG determined by a line of business domain associated with the first data object.

5. The method of claim 1, wherein the plurality of data objects are not extracted from the plurality of data sources.

6. The method of claim 1, further comprising:
determining, by the server, the tokenized data elements are non-integer business keys data elements;
generating, by the server, integer surrogate keys for the non-integer business keys data elements; and
replacing, by the server, the non-integer business keys data elements with the integer surrogate keys.

7. The method of claim 1, wherein the consumption layer comprises only a tokenized consumption view, wherein the consumption layer does not detokenize of the plurality of data objects according to a data protection policy.

8. The method of claim 1, the plurality of data objects are mapped to a base view in the base layer in a one-to-one relationship, wherein one-to-one relationship eliminates inconsistencies in data retrieval from the plurality of data sources.

9. The method of claim 1, wherein the plurality of classification tags implement a data security schema associated with data privacy standards, and wherein the data privacy standards comprise California Consumer Privacy Act (CCPA), Gramm-Leach-Bliley Act (GLBA), general data protection regulation (GDPR), Payment Card Industry Data Security Standard (PCI DSS), and Health Insurance Portability and Accountability Act (HIPAA).

10. The method of claim 1, wherein the plurality of data objects are tokenized in the base layer, the integration layer, and the consumption layer of the data virtualization platform.

11. The method of claim 1, wherein the integration layer comprises a plurality of federated pipelines connecting the base layer and the consumption layer.

12. The method of claim 11, wherein the plurality of federated pipelines are associated with domain-specific data products.

13. A data virtualization system comprising:
a global load balancer configured to:
receive a plurality of query requests from a plurality of client devices; and
direct a query request of the plurality of query requests to a first load balancer in a first production environment or a second load balancer in a second production environment;
a first deployment server communicably coupled to the first load balancer in the first production environment, wherein the first load balancer is positioned between the first deployment server and the global load balancer;
a second deployment server communicably coupled to the second load balancer in the second production environment, wherein the second load balancer is positioned between the first deployment server and the global load balancer;
a third load balancer communicably coupled to the first deployment server, wherein the third load balancer is positioned between the first deployment server and a plurality of data sources;
a fourth load balancer communicably coupled to the first deployment server, wherein the third load balancer is positioned between the second deployment server and the plurality of data sources; and
the third load balancer is configured to:
receive a first query request of the plurality of query requests;
determine a first latency response time between the third load balancer and the plurality of data sources in the first production environment;
determine a second latency response time between the fourth load balancer and the plurality of data sources in the second production environment, and route the first query request through the second production environment when the second latency response time is less than the first latency response time; and
route the first query request through the first production environment when the first latency response time is less than the second latency response time.

14. The data virtualization system of claim 13, wherein the fourth load balancer is configured to:
receive a second query request of the plurality of query requests;
determine a third latency response time between the fourth load balancer and the plurality of data sources in the second production environment;
determine a fourth latency response time between the third load balancer and the plurality of data sources in the first production environment, and route the second query request through the first production environment when the fourth latency response time is less than the third latency response time; and
route the second query request through the second production environment when the third latency response time is less than the fourth latency response time.

15. The data virtualization system of claim 13, wherein the first deployment server comprises a first active server and a first warm backup server, and wherein the first load balancer is configured to route a third query request of the plurality of query requests to the first warm backup server of the first deployment server based on a server outage in the second production environment.

16. The data virtualization system of claim 15, wherein the second deployment server comprises a second active server and a second warm backup server, and wherein the first load balancer is configured to route a fourth query request of the plurality of query requests to a warm backup server of the first deployment server based on the server outage in the second production environment.

17. The data virtualization system of claim 16, wherein the first load balancer is configured to:
determine that the first active server of the first deployment server is offline in the first production environment; and
route a fifth query request of the plurality of query requests to the first warm backup server of the first deployment server or the second deployment server.
